(19) United States
(12) Patent Application Publication
(10) Pub. No.: US 2026/0368191 A1
(43) Pub. Date: Nov. 19, 2026

(54) SEARCH APPARATUS, SEARCH METHOD, AND NON-TRANSITORY COMPUTER-READABLE MEDIUM

(71) Applicant: NEC Corporation, Tokyo (JP)

(72) Inventors: Noboru YOSHIDA, Tokyo (JP); Tingting DONG, Tokyo (JP); Kun YI, Tokyo (JP); Jianquan LIU, Tokyo (JP)

(73) Assignee: NEC Corporation, Tokyo (JP)

(21) Appl. No.: 19/138,738

(22) PCT Filed: Dec. 8, 2023
(86) PCT No.: PCT/JP2023/044045

§ 371 Date: Jun. 13, 2025

(30) Foreign Application Priority Data
Dec. 21, 2022 (JP) 2022-204369

(51) Int. Cl. G06F 16/2457; G06F 16/242

(52) U.S. Cl. CPC G06F 16/24578; G06F 16/242

(57) ABSTRACT

The present invention provides a search apparatus including: an input acceptance unit that accepts a search query specifying an attribute value and a certainty factor of the attribute value for at least one attribute; a correction unit that generates a corrected search query by correcting the search query, based on reference information indicating another attribute value that may be confused with each attribute value, and the attribute value and the certainty factor that are specified by the search query; a search unit that searches one or more pieces of registration information registered in a database for registration information matching the corrected search query; and a recommendation unit that determines and outputs an attribute or an attribute value recommended to be specified by the search query, based on at least one of the corrected search query and the reference information.

### TECHNICAL FIELD

The present invention relates to a search apparatus, a search method, and a program.

### BACKGROUND ART

Patent Documents 1 to 6 disclose technologies related to the present invention.

A technology disclosed in Patent Document 1 searches for an image matching a search condition specified by a user and displays the search result. Then, the technology accepts user input about whether an image included in the search result is a desired search result. Then, the technology provides an attribute appearing in desired search results in common to the user as an attribute to be added to the search condition.

A technology disclosed in Patent Document 2 extracts a feature value from an image in which a person is captured and determines a certainty factor indicating reliability of the feature value. Then, the technology performs an image search by using the certainty factor.

Technologies disclosed in Patent Documents 3 to 6 each search for an image including a person matching a search query. The search query specifies gender, age, the color of clothing, the type of clothing, glasses, the length of hair, the color of hair, belongings, and the like.

### RELATED DOCUMENT

### Patent Document

Patent Document 1: Japanese Patent Application Publication No. 2018-142160
Patent Document 2: Japanese Patent Application Publication No. 2020-198053
Patent Document 3: International Application Publication No. WO 2022/201541
Patent Document 4: International Application Publication No. WO 2020/255307
Patent Document 5: Japanese Patent Application Publication No. 2022-062675
Patent Document 6: Japanese Patent Application Publication No. 2006-178721

### SUMMARY

### Technical Problem

A user sets a search query specifying an attribute value (a feature) of a desired search target and searches for the desired search target. Examples of a search include a search for an image including a desired person, a search for an image captured at a desired location, and a search for an image including a desired object but are not limited thereto.

In a case where a wide variety of attribute values are settable in a search query in such a search, a search result narrowed down to desired information with high precision from among pieces of information registered in a database can be acquired. In other words, inconvenience of information other than a desired search target being included in a search result can be mitigated. However, in a case where there are many options of settable attribute value, a user may waver in an attribute value to be set and may not be able to suitably set a search query. For example, the user may set a search query with incorrect contents. None of Patent Documents 1 to 6 disclose such an issue and a solution.

An example of an object of the present invention is to, in view of the aforementioned issue, provide a search apparatus, a search method, and a program that resolve an issue of enabling a user to set a suitable search query.

### Solution to Problem

According to an example aspect of the present invention, a search apparatus including:
an input acceptance unit that accepts a search query specifying an attribute value and a certainty factor of the attribute value for at least one attribute;
a correction unit that generates a corrected search query by correcting the search query, based on reference information indicating the another attribute value that may be confused with the each attribute value, and the attribute value and the certainty factor that are specified by the search query;
a search unit that searches one or more pieces of registration information registered in a database for the registration information matching the corrected search query; and
a recommendation unit that determines and outputs the attribute or the attribute value recommended to be specified by the search query, based on at least one of the corrected search query and the reference information is provided.

According to an example aspect of the present invention, a search method including, by one or more computers:
accepting a search query specifying an attribute value and a certainty factor of the attribute value for at least one attribute;
generating a corrected search query by correcting the search query, based on reference information indicating the another attribute value that may be confused with the each attribute value, and the attribute value and the certainty factor that are specified by the search query;
searching one or more pieces of registration information registered in a database for the registration information matching the corrected search query; and
determining and outputting the attribute or the attribute value recommended to be specified by the search query, based on at least one of the corrected search query and the reference information
   is provided.

According to an example aspect of the present invention, a program causing a computer to function as:
an input acceptance unit that accepts a search query specifying an attribute value and a certainty factor of the attribute value for at least one attribute;
a correction unit that generates a corrected search query by correcting the search query, based on reference information indicating the another attribute value that may be confused with the each attribute value, and the attribute value and the certainty factor that are specified by the search query;
a search unit that searches one or more pieces of registration information registered in a database for the registration information matching the corrected search query; and
a recommendation unit that determines and outputs the attribute or the attribute value recommended to be specified by the search query, based on at least one of the corrected search query and the reference information
   is provided.

### Advantageous Effects of Invention

According to the example aspects of the present invention, a search apparatus, a search method, and a program that resolve the issue of enabling a user to set a suitable search query are provided.

### BRIEF DESCRIPTION OF THE DRAWINGS

The aforementioned object, and other objects, features, and advantages will become more apparent by the following suitable example embodiments and accompanying drawings.

FIG. 1 It is a diagram illustrating an example of a functional block diagram of a search apparatus.

FIG. 2 It is a diagram illustrating an example of a hardware configuration of the search apparatus.

FIG. 3 It is a diagram schematically illustrating an example of reference information.

FIG. 4 It is a diagram schematically illustrating an example of index information.

FIG. 5 It is a diagram schematically illustrating an example of a history of search queries.

FIG. 6 It is a diagram schematically illustrating another example of a history of search queries.

FIG. 7 It is a diagram for illustrating an example of processing of determining recommended contents.

FIG. 8 It is a diagram illustrating an example of a technique of outputting recommendation information.

FIG. 9 It is a diagram illustrating an example of a technique of outputting recommendation information.

FIG. 10 It is a flowchart illustrating an example of a flow of processing in the search apparatus.

FIG. 11 It is a flowchart illustrating another example of a flow of processing in the search apparatus.

FIG. 12 It is a diagram schematically illustrating another example of reference information.

FIG. 13 It is a diagram schematically illustrating another example of reference information.

FIG. 14 It is a diagram schematically illustrating another example of reference information.

FIG. 15 It is a diagram schematically illustrating another example of reference information.

### EXAMPLE EMBODIMENT

Example embodiments of the present invention will be described below by using drawings. Note that in every drawing, similar components are given similar signs, and description thereof is omitted as appropriate.

### First Example Embodiment

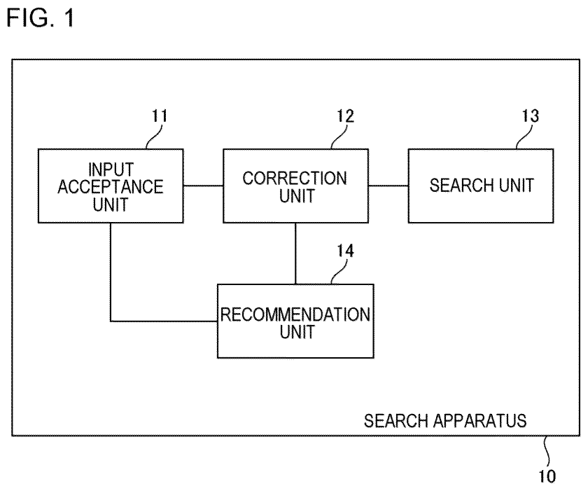

FIG. 1 is a functional block diagram illustrating an overview of a search apparatus 10 according to a first example embodiment. The search apparatus 10 includes an input acceptance unit 11, a correction unit 12, a search unit 13, and a recommendation unit 14.

The input acceptance unit 11 accepts a search query specifying an attribute value and a certainty factor of the attribute value for at least one attribute. The correction unit 12 generates a corrected search query by correcting the search query, based on reference information indicating another attribute value that may be confused with each attribute value, and an attribute value and a certainty factor that are specified by the search query. The search unit 13 searches pieces of registration information registered in a database for registration information matching the corrected search query. The recommendation unit 14 determines and outputs an attribute or an attribute value recommended to be specified by the search query, based on at least one of the corrected search query and the reference information.

Such a search apparatus 10 enables a user to suitably set a search query, based on recommended contents. Further, the search apparatus 10 determines an attribute or an attribute value recommended to be specified by a search query, based on the aforementioned characteristic information. Such a search apparatus 10 enables recommendation of a suitable attribute or attribute value.

### Second Example Embodiment

### Overview

A search apparatus 10 according to a second example embodiment is a tangible form of the search apparatus 10 according to the first example embodiment. Details will be described below.

### “Hardware Configuration”

An example of a hardware configuration of the search apparatus 10 will be described. Each functional unit in the search apparatus 10 is provided by any combination of hardware and software. It may be understood by a person skilled in the art that various modifications to the implementation method and the apparatus can be made. For example, the software includes a program previously stored in the shipping stage of the apparatus, a program downloaded from a medium such as a compact disc (CD), a server on the Internet, or the like.

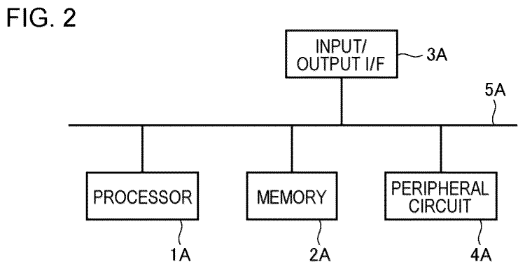

FIG. 2 is a block diagram illustrating a hardware configuration of the search apparatus 10. As illustrated in FIG. 2, the search apparatus 10 includes a processor TA, a memory 2A, an input-output interface 3A, a peripheral circuit 4A, and a bus 5A. Various modules are included in the peripheral circuit 4A. The search apparatus 10 may not include the peripheral circuit 4A. Note that the search apparatus 10 may be configured with a plurality of physically and/or logically separate apparatuses. In this case, each of the plurality of apparatuses may include the aforementioned hardware configuration.

The bus 5A is a data transmission channel for the processor TA, the memory 2A, the peripheral circuit 4A, and the input-output interface 3A to transmit and receive data to and from each other. Examples of the processor TA include arithmetic processing units such as a CPU and a graphics processing unit (GPU). Examples of the memory 2A include memories such as a random-access memory (RAM) and a read-only memory (ROM). The input-output interface 3A includes an interface for acquiring information from an input apparatus, an external apparatus, an external server, an external sensor, a camera, and the like, and an interface for outputting information to an output apparatus, the external apparatus, the external server, and the like. Further, the input-output interface 3A includes an interface for connecting to a communication network such as the Internet. Examples of the input apparatus include a keyboard, a mouse, a microphone, a physical button, and a touch panel. Examples of the output apparatus include a display, a speaker, a printer, and a mailer. The processor TA issues an instruction to each module and can perform an operation, based on the operation result by the module.

### “Functional Configuration”

Next, a functional configuration of the search apparatus 10 according to the present example embodiment will be described in detail. FIG. 1 illustrates an example of a functional block diagram of the search apparatus 10. As illustrated, the search apparatus 10 includes an input acceptance unit 11, a correction unit 12, a search unit 13, and a recommendation unit 14.

The input acceptance unit 11 accepts a search query specifying an attribute value and a certainty factor of the attribute value for at least one attribute. An example of a search query will be described below.

“male: 100% AND thirties: 70% AND wearing red trousers: 100%”

An “attribute” is an attribute of a search target. A plurality of attributes that can be used in a search for a search target are preset. Set attributes vary with each search target. Examples of a search target include a person, a location, and an object. A user setting a search query determines an attribute to be used in the search query within a range of preset attributes and specifies an attribute value of the determined attribute.

Examples of an attribute in a case where a search target is a person include gender, age, nationality, a physical constitution, a height, a weight, a hairstyle, a feature of clothing, a feature of belongings, a pose, and a movement but are not limited thereto. The attributes may be further subdivided. For example, a feature of clothing may be subdivided into a feature of headwear, a feature of glasses, a feature of a coat, and a feature of shoes.

Examples of an attribute in a case where a search target is a location include a type of an object existing at the location (e.g., a tree, a building, or a signboard) and features (e.g., a color, a shape, and/or a size) of the external appearance of the object but are not limited thereto.

Examples of an attribute in a case where a search target is an object include the type of the object (e.g., a desk, a chair, a tree, a building, or a signboard) and features (e.g., a color, a shape, and/or a size) of the external appearance of the object but are not limited thereto.

In the case of the aforementioned example of a search query, the search target is a person, and attribute values of three attributes being gender, age, and a feature of clothing are specified.

An “attribute value” indicates specific contents of an attribute as described above. For example, attribute values of an “attribute: gender” are male and female. A plurality of selectable attribute values may be preset for each attribute. Then, a user setting a search query may determine an attribute value to be used in the search query within a range of the preset selectable attribute values. Note that the way input of an attribute value is accepted exemplified above is strictly an example and is not limited thereto.

In the case of the aforementioned example of a search query, “male” is specified as an attribute value of the “attribute: gender.” “Thirties” is specified as an attribute value of an “attribute: age.” “Wearing red trousers” is specified as an attribute value of an “attribute: a feature of clothing.”

A “certainty factor” indicates a degree of certainty of each attribute value specified as a search query matching an attribute value of a search target (i.e., being correct). A user specifies a certainty factor for each attribute value specified as a search query. For example, a certainty factor is specified as a value between 0 and 100% but is not limited thereto. For example, a user can decrease the certainty factors of an attribute value of a search target heard from another person being unreliable and an attribute value of a search target recalled from a memory in the distant past. Further, for example, a user may increase the certainty factors of an attribute value of a search target heard from another person being reliable and an attribute value of a recently sighted search target.

In the case of the aforementioned example of a search query, a numerical value displayed after each attribute value indicates the certainty factor of the attribute value.

A means for accepting input of a search query by the input acceptance unit 11 is not particularly limited. For example, the input acceptance unit 11 may accept input of a search query through an input apparatus included in the search apparatus 10. In addition, the search apparatus 10 may be a server. Then, the input acceptance unit 11 may acquire a search query transmitted from a client terminal.

The correction unit 12 generates a corrected search query by correcting a search query, based on reference information indicating another attribute value that may be confused with each attribute value, and an attribute value and a certainty factor that are specified by the search query.

In a case where a search query is set based on vague memory of a user, contents heard from another person, or the like, an attribute value of a search target may be confused within a certain range, and an incorrect search query may be set. The confusion range falls within a certain range and rarely goes out of the range. For example, a person in thirties may be confused with a person in twenties, forties, or fifties but is rarely confused with a person in teens or younger or a person in sixties or older. The correction unit 12 is configured to correct a search query set by a user, based on such regularity.

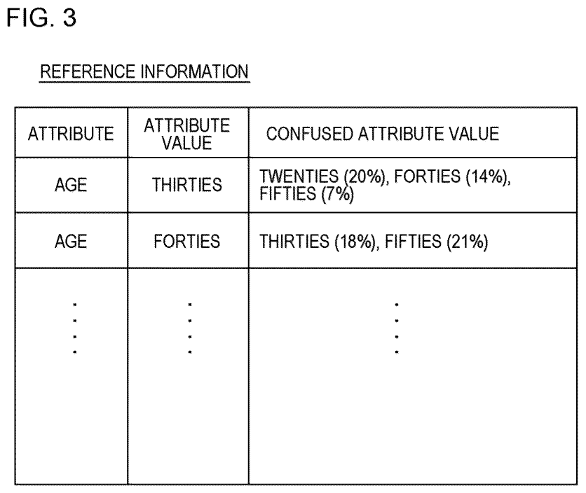

For example, reference information as illustrated in FIG. 3 may be previously generated and be registered in the search apparatus 10. The reference information illustrated in FIG. 3 indicates “other attribute values that may be confused with each attribute value specified by a search query” and “the possibility of the attribute value being confused with each of the other attribute values.” One attribute value is determined by the values of an “attribute” field and an “attribute value” field. Then, a “confused attribute value” field indicates other attribute values that may be confused with one attribute value determined by the values of the “attribute” field and the “attribute value” field. Note that a numerical value associated with each attribute value indicated in the “confused attribute value” field indicates the possibility of the one attribute value being confused with each of the other attribute values.

In a case where “thirties” is specified in a search query, the reference information illustrated in FIG. 3 indicates that a person being the search target may actually be in twenties, forties, or fifties. Furthermore, the reference information illustrated in FIG. 3 indicates the possibility of the search target person being actually in twenties (20%), the possibility of the person being in forties (14%), and the possibility of the person being in fifties (7%).

Such reference information may be generated by any means. For example, an administrator of the search apparatus 10 (e.g., a person in charge at the manufacturer) gets a plurality of subjects to view a person in each age group and gets each subject to answer the age of the person assumed by the subject. Then, the administrator of the search apparatus 10 can generate reference information as illustrated in FIG. 3 by compiling the answer results. Note that the administrator of the search apparatus 10 may perform the experiment under a varied condition. For example, the administrator of the search apparatus 10 may get a plurality of subjects to view a person in each age group without telling details and get each subject to answer the age of the person assumed by the subject after a lapse of a certain time (e.g., after several days). As another example of the way reference information is generated, the administrator of the search apparatus 10 may generate reference information as illustrated in FIG. 3, based on experience and sense of the administrator. Note that the way reference information is generated exemplified above is strictly an example and is not limited thereto.

A specific example of processing of correcting a search query, based on the reference information illustrated in FIG. 3, will be described.

For example, the correction unit 12 can generate a corrected search query described below from a search query described below, based on the reference information illustrated in FIG. 3. Twenties: 14%, forties: 10%, and fifties: 6% are given to the search query by using AND conditions in the following correction. Features of the correction processing will be described below. (search query) “male: 100% AND thirties: 70% AND wearing red trousers: 100%” (corrected search query) “male: 100% AND thirties: 70% AND twenties: 14% AND forties: 10% AND fifties: 6% AND wearing red trousers: 100%”

### Feature 1

As described in the aforementioned correction example, in a case where a search query includes an attribute value (a first attribute value) of a certain attribute (a first attribute), the correction unit 12 generates a corrected search query including the attribute value (the first attribute value) of the attribute (the first attribute) and another attribute value (a second attribute value) of the attribute (the first attribute).

The search query in the aforementioned correction example includes attribute values of three attributes being gender, age, and a feature of clothing. The three attributes are first attributes. Then, male, thirties, and wearing red trousers being respective attribute values of the attributes are first attribute values.

A correction is made to thirties out of the three first attribute values in the aforementioned correction example. The correction unit 12 generates a corrected search query including “thirties (a first attribute value)” and “twenties, forties, and fifties (second attribute values) being other attribute values of the same attribute as thirties (the first attribute value).” The second attribute values are confused attribute values associated with the first attribute value in the reference information illustrated in FIG. 3. In other words, a second attribute value is an attribute value indicated in the reference information illustrated in FIG. 3 to have a possibility of being confused with the first attribute value.

Note that the correction unit 12 may make a similar correction to other first attribute values, or specifically, male and wearing red trousers. However, the first attribute values are not set to be targets of correction in the aforementioned correction example. The reason will become apparent in a feature 3 described below.

### Feature 2

As described in the aforementioned correction example, the correction unit 12 can determine the certainty factor of a second attribute value in a corrected search query, based on the possibility of each attribute value being confused with another attribute value, the possibility being indicated in reference information.

There are various methods for computing the certainty factor of a second attribute value using the possibility of each attribute value being confused with another attribute value, the possibility being indicated in reference information. In the aforementioned correction example, the correction unit 12 proportionally divides a value acquired by subtracting the certainty factor of a first attribute value set by a user from 100% into a plurality of second attribute values according to the possibility of the first attribute value being confused with each second attribute value.

Specifically, the certainty factor of thirties (a first attribute value) is 70% in the search query in the aforementioned correction example. Therefore, the correction unit 12 proportionally divides 30% being a value acquired by subtracting 70% from 100% into a plurality of second attribute values (twenties, forties, and fifties) according to the possibilities of being confused with thirties (twenties: 20%, forties: 14%, and fifties: 7%).

The certainty factor (70%) of a first attribute value set by the user is not corrected in the aforementioned correction example. As another example, the certainty factor (70%) of the first attribute value set by the user may be corrected. For example, the reference information illustrated in FIG. 3 indicates the possibility (20%) of thirties being confused with twenties, the possibility (14%) of thirties being confused with forties, and the possibility (7%) of thirties being confused with fifties. Thus, the possibility of thirties not being confused with another age can be considered 59% [=100%−(20%+14%+7%)]. Then, the correction unit 12 may generate a corrected search query as follows by using the possibility indicated in the reference information as a certainty factor on an as-is basis.

(another example of a corrected search query) “male: 100% AND thirties: 59% AND twenties: 20% AND forties: 14% AND fifties: 7% AND wearing red trousers: 100%”

### Feature 3

As described in the aforementioned correction example, the correction unit 12 may set an attribute value the certainty factor of which satisfies a predetermined condition to be a target of correction. Then, the correction unit 12 does not set an attribute value the certainty factor of which does not satisfy the predetermined condition to be a target of correction.

The predetermined condition is “the certainty factor being less than a reference value.” The reference value may be 100% or a smaller value. In a case where a certainty factor is high to some extent, a user confidently specifies the attribute value as a search query. It is considered unnecessary to correct such an attribute value.

Each of the certainty factors of male and wearing red trousers is 100% and is equal to or greater than the reference value in the aforementioned correction example. Therefore, the attribute values are not set to be targets of correction. Then, other attribute values that may be confused with the attribute values are not included in the corrected search query.

Note that as a modified example, every attribute value included in a search query may be set to be a target of correction regardless of the certainty factor.

Returning to FIG. 1, the search unit 13 searches pieces of registration information registered in a database for registration information matching the corrected search query generated by the correction unit 12. Registration information is an image but may be text, voice, or the like. Note that the search unit 13 may perform the aforementioned search by using a search query set by a user in place of the corrected search query. Specifically, the search unit 13 may search the pieces of registration information registered in the database for registration information matching a search query set by the user.

Search processing performed by the search unit 13 will be specifically described below. While a case of a person being a search target will be described as an example, search processing can be performed by similar processing in a case of a location, another object, or the like being a search target.

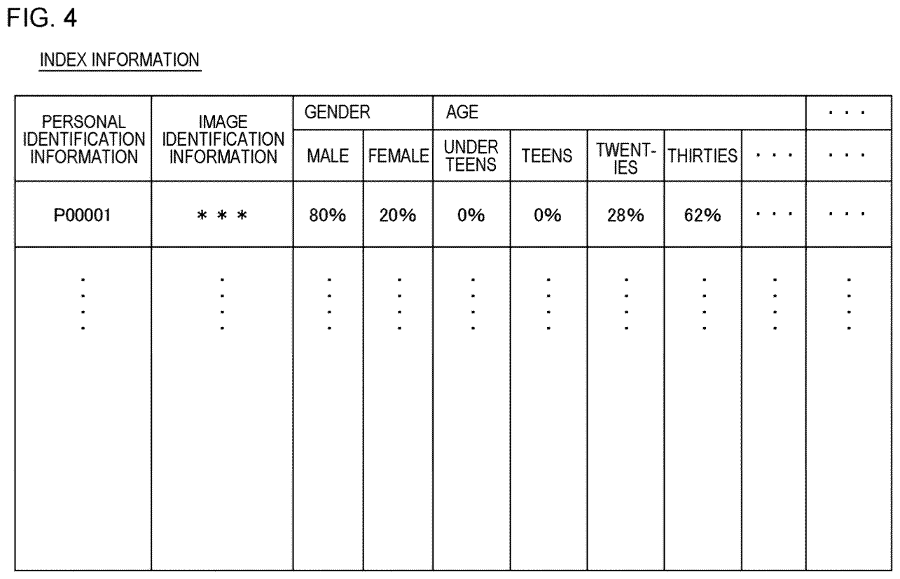

First, index information as illustrated in FIG. 4 is generated by analyzing a plurality of pieces of registration information. The timing of generation of the index information is not particularly limited. The index information may be previously generated prior to the timing of a search or may be generated at the timing of a search.

The index information illustrated in FIG. 4 indicates personal identification information, image identification information, attribute values of each person, and the certainty factors of the respective attribute values.

“Personal identification information” is information for identifying each of a plurality of persons detected from an image being registration information.

“Image identification information” is information for identifying an image in which each person is captured. An image file name may be indicated in the image identification information. In addition, the file name of a dynamic image file and information indicating part of the dynamic image file (time information such as the time elapsed from the beginning) may be indicated in the image identification information.

“An attribute value and the certainty factor thereof” indicate the certainty factor of each person with each attribute value. Note that, in order to distinguish certainty factors indicated by a search query and a corrected search query from a certainty factor indicated by the index information, the certainty factor indicated in the index information is hereinafter referred to as an index certainty factor. For example, an attribute value of each person detected from registration information and the index certainty factor of the attribute value are computed by using a classifier generated by machine learning.

The search unit 13 computes a degree of matching with a corrected search query for each person indicated in the index information. Then, the search unit 13 searches for an image including a person the degree of matching of whom satisfies a predetermined matching condition as an image matching the corrected search query. The matching condition may be “the degree of matching being equal to or greater than a threshold value.” Further, the matching condition may be “the degree of matching of a person out of a plurality of persons indicated in the index information is included within a predetermined ratio from the top or within a predetermined number from the top.” Note that the matching conditions exemplified above are examples and are not limited thereto.

A degree of matching is computed based on an attribute value and a certainty factor that are indicated by a corrected search query and the index certainty factor of the attribute value (the attribute value indicated by the corrected search query) indicated in the index information. A person with a higher index certainty factor of an attribute value indicated in a corrected search query has a higher degree of matching.

For example, a degree of matching M may be computed by a formula M=C₁×IC₁+C₂×IC₂+ . . . Cₙ×ICₙ.

Note that n denotes a sequential number of an attribute value included in a corrected search query. For example, in a case where a corrected search query has the following contents, n denotes a sequential number of each of six attribute values being male, thirties, twenties, forties, fifties, and wearing red trousers.

(Corrected search query) “male: 100% AND thirties: 70% AND twenties: 14% AND forties: 10% AND fifties: 6% AND wearing red trousers: 100%”

Cₙ denotes the certainty factor of an n-th attribute value included in the corrected search query.

ICₙ denotes the index certainty factor of “the n-th attribute value included in the corrected search query” of a person being a processing target (a computation target of a degree of matching) indicated in the index information.

Note that the aforementioned formula is strictly an example and is not limited thereto. For example, the search unit 13 may compute a statistical value of Cₙ×ICₙ for each attribute and compute the total value by adding up the statistical values for the respective attributes as a degree of matching M. Examples of a statistical value include a mean, a median, a mode, a maximum value, and a minimum value. The aforementioned corrected search query includes three attributes being gender, age, and a feature of clothing. Then, the search unit 13 computes a statistical value of Cₙ×ICₙ in association with each of gender, age, and a feature of clothing. Then, the search unit 13 computes the total value by adding up the three computed statistical values as a degree of matching M. Thus, the contribution ratio of each of a plurality of attributes to the degree of matching M can be equalized.

The search unit 13 can output a search result. For example, the search unit 13 can output matching registration information. As an example, the search unit 13 may output matching registration information through a display or a projector included in the search apparatus 10. In addition, in a case where the search apparatus 10 is a server, the search unit 13 can transmit matching registration information to a client terminal.

In a case where there are a plurality of pieces of matching registration information, the search unit 13 may display the pieces of registration information by arrangement in descending order of degree of matching. The search unit 13 can output information displaying matching registration information by using any display technique.

Returning to FIG. 1, the recommendation unit 14 determines and outputs an attribute or an attribute value recommended to be specified by a search query. The recommendation unit 14 determines candidates of an attribute or an attribute value recommended to be specified by a search query by a characteristic technique. Then, the recommendation unit 14 determines an attribute or an attribute value recommended to be specified by the search query from among the aforementioned candidates, based on at least one of the aforementioned corrected search query and the aforementioned reference information. Processing of determining candidates of a recommended attribute or attribute value and processing of determining a recommended attribute or attribute value from among the candidates will be described in detail below.

### —Processing of Determining a Candidate of an Attribute or an Attribute Value Recommended to be Specified by a Search Query—

The recommendation unit 14 can determine a candidate of an attribute or an attribute value recommended to be specified by a search query, based on at least one of the following. Examples of candidate determination processing (candidate determination processing examples 1 to 5) based on the following will be described in detail below.
a history of search queries set in the past
a search query set at that point in time
a search result based on a search query set at that point in time

### Candidate Determination Processing Example 1: Processing of Determining a Candidate of a Recommended Attribute or Attribute Value, Based on a History of Search Queries Set in the Past

The recommendation unit 14 can determine a candidate of an attribute or an attribute value recommended to be specified by a search query, based on a history of search queries set in the past.

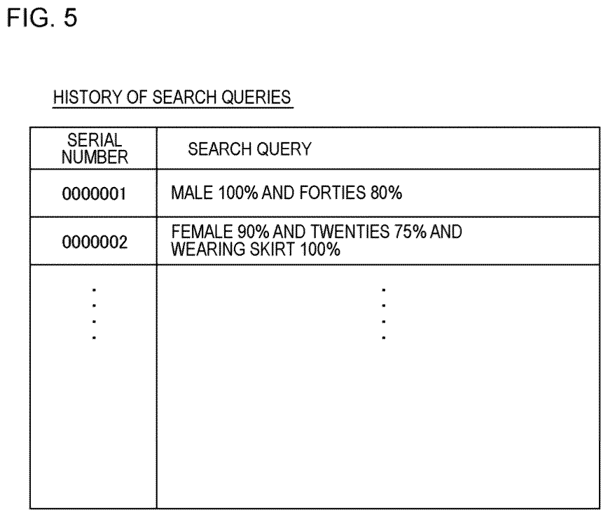

First, a history of search queries set in the past is registered in the search apparatus 10 as illustrated in FIG. 5. The recommendation unit 14 can determine a candidate of an attribute or an attribute value recommended to be specified by a search query, based on such a history of search queries.

For example, the recommendation unit 14 can determine at least one of the following attributes and attribute values as a candidate of an attribute or an attribute value recommended to be specified by a search query.
an attribute specified by a search query set in the past
an attribute value specified in a search query set in the past
an attribute specified a predetermined number of times or more in search queries set in the past
an attribute value specified a predetermined number of times or more in search queries set in the past
an attribute out of a plurality of attributes, the number of times the attribute is specified in search queries set in the past being included within a predetermined number or within a predetermined ratio from the top
an attribute value out of a plurality of attribute values, the number of times the attribute value is specified in search queries set in the past being included within a predetermined number or within a predetermined ratio from the top

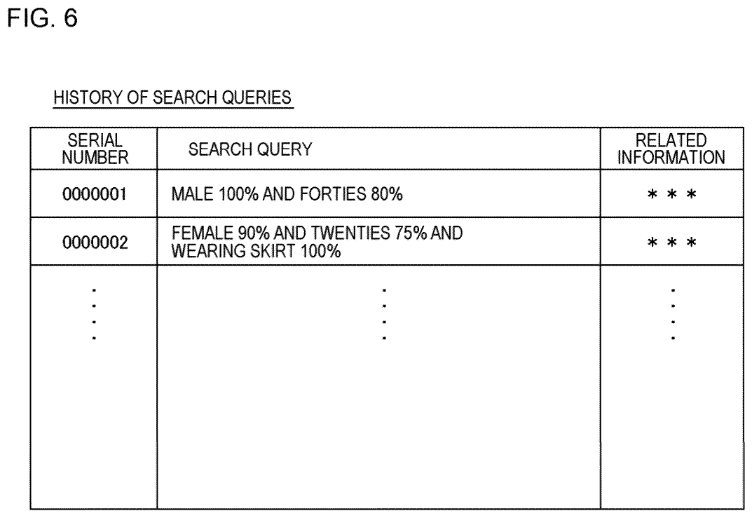

As another example, a history of search queries set in the past may be registered in the search apparatus 10, as illustrated in FIG. 6. In the example illustrated in FIG. 6, related information of each set search query is registered in association with the search query.

Related information includes at least one of a set date and time, and input information input by a user. Input information is input with a search query at the time of a search.

Input information may include at least one of the following examples.
identification information of a user setting a search query
various characteristics (e.g., gender, age, nationality, a department to which the user belongs, and occupation) of the user setting the search query
the purpose of the search (e.g., a stray child search, a criminal search, or a lost property search)
the location where the search target was sighted
the environment at the time when the search target was sighted (e.g., a time period, daytime/nighttime, and/or outdoors/indoors)
various characteristics (e.g., gender, age, and nationality) of the eyewitness sighting the search target

The recommendation unit 14 can determine a candidate of an attribute or an attribute value recommended to be specified by a search query, based on such a history of search queries.

For example, the recommendation unit 14 may determine at least one of the following attributes and attribute values as a candidate of an attribute or an attribute value recommended to be specified by a search query.
an attribute specified by a search query out of search queries set in the past, a predetermined condition being satisfied between the related information of the search query and related information set by a user in this search
an attribute value specified by a search query out of search queries set in the past, a predetermined condition being satisfied between the related information of the search query and related information set by a user in this search
an attribute specified a predetermined number of times or more by search queries out of search queries set in the past, a predetermined condition being satisfied between the related information of the search queries and related information set by a user in this search
an attribute value specified a predetermined number of times or more by a search queries out of search queries set in the past, a predetermined condition being satisfied between the related information of the search queries and related information set by a user in this search
an attribute out of a plurality of attributes, the number of times the attribute is specified by search queries out of search queries set in the past being included within a predetermined number or within a predetermined ratio from the top, a predetermined condition being satisfied between the related information of the search queries and related information set by a user in this search
an attribute value out of a plurality of attributes, the number of times the attribute value is specified by search queries out of search queries set in the past being included within a predetermined number or within a predetermined ratio from the top, a predetermined condition being satisfied between the related information of the search queries and related information set by a user in this search

Examples of the aforementioned predetermined condition related to related information include the following but are not limited thereto.
contents match in at least one of various items included in related information set by a user in this search
contents match in a predetermined number of items or more out of various items included in related information set by a user in this search
contents match in predetermined ratio of items or more out of various items included in related information set by a user in this search
contents match in all of various items included in related information set by a user in this search

Various items included in related information set by a user in this search include a setting date and time, identification information of a user, various items related to characteristics of the user, the purpose of the search, the location where the search target was sighted, various items related to the environment at the time when the search target was sighted, and various items related to characteristics of an eyewitness sighting the search target.

### Candidate Determination Processing Example 2: Processing of Determining a Candidate of an Attribute or an Attribute Value to be Recommend, Based on a Search Query Set at that Point in Time

First, registration information in the example is an image. Then, an attribute value is a feature of the external appearance of a person being a search target. Then, the search unit 13 searches for an image including a person matching a set search query.

On such an assumption, the recommendation unit 14 can determine an attribute or an attribute value satisfying a predetermined relation with an attribute or an attribute value specified by a search query set at that point in time as a candidate of an attribute or an attribute value recommended to be specified by the search query. “That point in time” refers to a point in time when recommendation information is output.

Specifically, in a case where an attribute value related to a part of the body of a person being the search target is specified by a search query, the recommendation unit 14 can determine at least one of the following attributes and attribute values as a candidate of an attribute or an attribute value recommended to be specified by the search query. Note that a part of the body related to an attribute value specified by the search query is referred to as a “specified part.”
another attribute related to the specified part
another attribute value related to the specified part
an attribute related to another part of the body satisfying a predetermined positional relation with the specified part
an attribute value related to another part of the body satisfying a predetermined positional relation with the specified part

For example, it is assumed that “wearing red headwear” is specified by the search query. In this case, the specified part is “the head.” Then, the attribute is “a feature of headwear.”

Examples of “another attribute related to the specified part” in this case include “a feature of glasses” and “a feature of a mask.” Further, examples of “another attribute value related to the specified part” include “wearing black glasses” and “wearing a red mask.” For example, an attribute value may be determined by any means, based on “a history of search queries set in the past” described in the second example embodiment. In a case where an attribute value of a certain attribute related to the specified part is specified, the possibility of a user also recognizing and remembering the contents of another attribute of the specified part is high, and therefore, the recommendation is made.

“A predetermined positional relation with the specified part” is a relation at a short distance to the specified part. In a case where the specified part is “the head,” examples of “another part of the body satisfying a predetermined positional relation with the specified part” include “the neck” and “the upper half of the body.”

Examples of “an attribute related to another part of the body satisfying a predetermined positional relation with the specified part” in this case include “a feature of clothing on the upper half of the body.” Further, examples of “an attribute value related to another part of the body satisfying a predetermined positional relation with the specified part” include “wearing a red coat.” In a case where an attribute value of a certain attribute related to the specified part is specified, the possibility of a user also recognizing and remembering the contents of an attribute of a part close to the specified part is high, and therefore, the recommendation is made.

The body is previously classified into a plurality of parts, and information indicating an attribute and an attribute value belonging to each part is registered in the search apparatus 10. Further, information indicating another part satisfying the aforementioned predetermined positional relation with each part is registered in the search apparatus 10. The recommendation unit 14 can determine an attribute or an attribute value satisfying the condition as described above, based on the pieces of information.

Note that “a search query set at that point in time” may read as “a corrected search query set at that point in time” in the candidate determination processing example 2.

### Candidate Determination Processing Example 3: Processing of Determining a Candidate of a Recommended Attribute or Attribute Value, Based on a History of Search Queries Set in the Past and a Search Query Set at that Point in Time

The recommendation unit 14 can determine at least one of the following attributes and attribute values as a candidate of an attribute or an attribute value recommended to be specified by a search query.
an attribute specified by a search query set in the past with an attribute specified by a search query set at that point in time
an attribute value specified by a search query set in the past with an attribute value specified by a search query set at that point in time
an attribute specified a predetermined number of times or more by search queries set in the past with an attribute specified by a search query set at that point in time
an attribute value specified a predetermined number of times or more by a search query set in the past with an attribute value specified by search queries set at that point in time

“That point in time” refers to a point in time when recommendation information is output.

The aforementioned “attribute specified by a search query set at that point in time” may read as one of the following.
all attributes specified by a search query set at that point in time
at least one attribute out of attributes specified by a search query set at that point in time
a predetermined ratio or more of attributes specified by a search query set at that point in time

Further, the aforementioned “attribute value specified by a search query set at that point in time” may read as one of the following.
all attribute values specified by a search query set at that point in time
at least one attribute value out of attribute values specified by a search query set at that point in time
a predetermined ratio or more of attribute values specified by a search query set at that point in time

Each case will be described below taking a search query set at that point in time being “male: 100% AND thirties: 70%” as an example.

### Term Replacement Example 1: The Case of Reading as “all Attributes Specified by a Search Query Set at that Point in Time’

In this case, for example, the recommendation unit 14 can determine an attribute specified in the past with both gender and age as a candidate of an attribute recommended to be specified by a search query.

Note that the recommendation unit 14 may determine an attribute specified in the past with a combination of gender and age as a candidate of an attribute recommended to be specified by a search query. In addition, the recommendation unit 14 may determine an attribute specified in the past separately with gender and age as a candidate of an attribute recommended to be specified by a search query.

Further, for example, the recommendation unit 14 may determine an attribute specified in the past with both gender and age a predetermined number of times or more as a candidate of an attribute recommended to be specified by a search query.

Note that the recommendation unit 14 may determine an attribute specified in the past with a combination of gender and age a predetermined number of times or more as a candidate of an attribute recommended to be specified by a search query. In addition, the recommendation unit 14 may determine an attribute specified a predetermined number of times or more in the past separately with each of gender and age as a candidate of an attribute recommended to be specified by a search query.

### Term Replacement Example 2: The Case of Reading as “at Least One Attribute Out of Attributes Specified by a Search Query Set at that Point in Time”

In this case, for example, the recommendation unit 14 can determine an attribute specified in the past with at least one of gender and age as a candidate of an attribute recommended to be specified by a search query.

Further, for example, the recommendation unit 14 can determine an attribute specified in the past with at least one of gender and age a predetermined number of times or more as a candidate of an attribute recommended to be specified by a search query.

### Term Replacement Example 3: The Case of Reading as “a Predetermined Ratio or More of Attributes Specified by a Search Query Set at that Point in Time”

In this case, the recommendation unit 14 can determine an attribute specified in the past with a predetermined ratio or more of a plurality of attributes specified by a search query set at that point in time as a candidate of an attribute recommended to be specified by a search query.

Note that the recommendation unit 14 may determine an attribute specified in the past with a group of a predetermined ratio or more of a plurality of attributes specified by a search query set at that point in time as a candidate of an attribute recommended to be specified by a search query. In addition, the recommendation unit 14 may determine an attribute specified in the past separately with each of a predetermined ratio or more of a plurality of attributes specified by a search query set at that point in time as a candidate of an attribute recommended to be specified by a search query.

Further, the recommendation unit 14 may determine an attribute specified a predetermined number of times or more in the past with a predetermined ratio or more of a plurality of attributes specified by a search query set at that point in time as a candidate of an attribute recommended to be specified by a search query.

Note that the recommendation unit 14 may determine an attribute specified a predetermined number of times or more in the past with a group of a predetermined ratio or more of a plurality of attributes specified by a search query set at that point in time as a candidate of an attribute recommended to be specified by a search query. In addition, the recommendation unit 14 may determine an attribute specified a predetermined number of times or more in the past separately with each of a predetermined ratio or more of a plurality of attributes specified by a search query set at that point in time as a candidate of an attribute recommended to be specified by a search query.

### Term Replacement Example 4: The Case of Reading as “all Attribute Values Specified by a Search Query Set at that Point in Time”

In this case, for example, the recommendation unit 14 may determine an attribute value specified in the past with both male and thirties as a candidate of an attribute value recommended to be specified by a search query.

Note that the recommendation unit 14 may determine an attribute value specified in the past with a combination of male and thirties as a candidate of an attribute value recommended to be specified by a search query. In addition, the recommendation unit 14 may determine an attribute value specified in the past separately with each of male and thirties as a candidate of an attribute value recommended to be specified by a search query.

Further, for example, the recommendation unit 14 may determine an attribute value specified a predetermined number of times or more in the past with both male and thirties as a candidate of an attribute value recommended to be specified by a search query.

Note that the recommendation unit 14 may determine an attribute value specified a predetermined number of times or more in the past with a combination of male and thirties as a candidate of an attribute value recommended to be specified by a search query. In addition, the recommendation unit 14 may determine an attribute value specified a predetermined number of times or more in the past separately with each of male and thirties as a candidate of an attribute value recommended to be specified by a search query.

### Term Replacement Example 5: “the Case of Reading as “at Least One Attribute Value Out of Attribute Values Specified by a Search Query Set at that Point in Time”

In this case, for example, the recommendation unit 14 can determine an attribute value specified in the past with at least one of male and thirties as a candidate of an attribute value recommended to be specified by a search query.

Further, for example, the recommendation unit 14 can determine an attribute value specified a predetermined number of times or more in the past with at least one of male and thirties as a candidate of an attribute value recommended to be specified by a search query.

### Term Replacement Example 6: The Case of Reading as “a Predetermined Ratio or More of Attribute Values Specified by a Search Query Set at that Point in Time”

In this case, the recommendation unit 14 can determine an attribute value specified in the past with a predetermined ratio or more of a plurality of attribute values specified by a search query set at that point in time as a candidate of an attribute value recommended to be specified by a search query.

Note that the recommendation unit 14 may determine an attribute value specified in the past with a group of a predetermined ratio or more of a plurality of attribute values specified by a search query set at that point in time as a candidate of an attribute value recommended to be specified by a search query. In addition, the recommendation unit 14 may determine an attribute value specified in the past separately with each of a predetermined ratio or more of a plurality of attribute values specified by a search query set at that point in time as a candidate of an attribute value recommended to be specified by a search query.

Further, the recommendation unit 14 may determine an attribute value specified a predetermined number of times or more in the past with a predetermined ratio or more of a plurality of attribute values specified by a search query set at that point in time as a candidate of an attribute value recommended to be specified by a search query.

Note that the recommendation unit 14 may determine an attribute value specified a predetermined number of times or more in the past with a group of a predetermined ratio or more of a plurality of attribute values specified by a search query set at that point in time as a candidate of an attribute value recommended to be specified by a search query. In addition, the recommendation unit 14 may determine an attribute value specified a predetermined number of times or more in the past separately with each of a predetermined ratio or more of a plurality of attribute values specified by a search query set at that point in time as a candidate of an attribute value recommended to be specified by a search query.

Note that “a search query set at that point in time” may read as “a corrected search query set at that point in time” in the candidate determination processing example 3.

### Candidate Determination Processing Example 4: Processing of Determining a Candidate of a Recommended Attribute or Attribute Value, Based on a Search Result Based on a Search Query Set at that Point in Time

The recommendation unit 14 can determine at least one of the following attributes and attribute values as a candidate of an attribute or an attribute value recommended to be specified by a search query.
attribute values the ratio or the number of pieces of registration information including each of which in a set of a plurality of pieces of registration information matching in a search based on a search query set at that point in time is equal to or less than a threshold value
attribute values the ratio or the number of pieces of registration information including each of which in a set of a plurality of pieces of registration information matching in a search based on a search query set at that point in time is included within a predetermined ratio or within a predetermined number from the bottom

“That point in time” refers to a point in time when recommendation information is output.

The recommendation unit 14 can determine an attribute or an attribute value useful for narrowing down the number of pieces of registration information indicated by a search result to a smaller number as a candidate of a recommended attribute or attribute value.

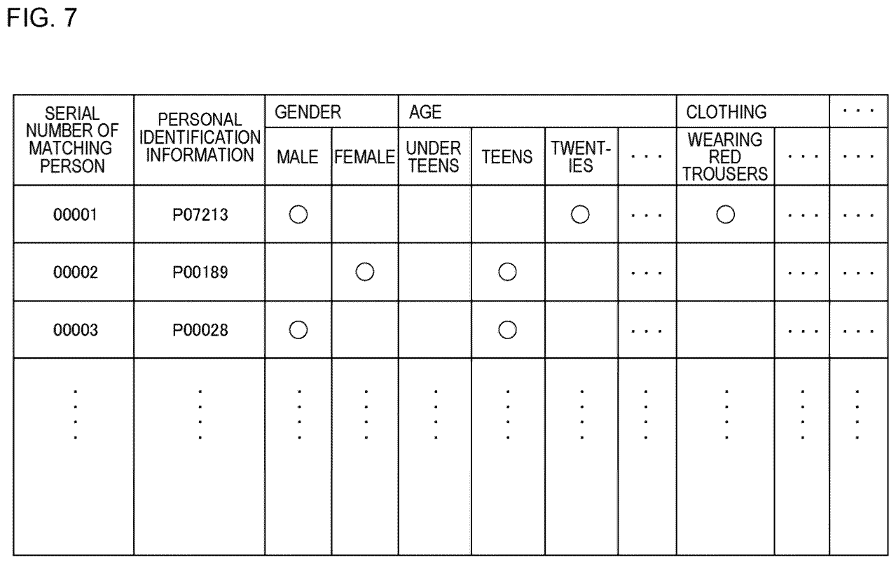

Processing performed by the recommendation unit 14 will be specifically described by using FIG. 7. Information in FIG. 7 relates to a set of a plurality of pieces of registration information matching in a search based on a search query set at that point in time. Specifically, the information in FIG. 7 indicates a list of persons indicated by a plurality of pieces of matching registration information (persons matching the search query).

“A sequential number of a matching person” refers to a sequential number given to each of a plurality of persons matching a search query set at that point in time.

“Personal identification information” refers to information for identifying each of a plurality of persons detected from an image being registration information (see FIG. 3).

The information in FIG. 7 indicates whether to include each attribute value in association with each person. The information means that each person has an attribute value marked with a circle. Examples of a criterion for determining inclusion of an attribute value include “the aforementioned index certainty factor (see FIG. 4) is equal to or greater than a threshold value” but are not limited thereto.

By counting the number of circles for each attribute value, based on the information in FIG. 7, the number of pieces of registration information (the number of persons) including each attribute value in a set of a plurality of pieces of registration information matching in a search based on a search query set at that point in time is computed. Then, based on the computed value and the total number of pieces of registration information (the total number of persons) matching in the search based on the search query set at that point in time, the aforementioned ratio can be computed.

Note that “a search query set at that point in time” may read as “a corrected search query set at that point in time” in the candidate determination processing example 4.

### Candidate Determination Processing Example 5: Processing of Determining a Candidate of a Recommended Attribute or Attribute Value, Based on a Search Query Set at that Point in Time

The recommendation unit 14 can determine a candidate of an attribute or an attribute value recommended to be specified by a search query, based on a learning model generated by machine learning and a search query set at that point in time.

The learning model inputs a search query and outputs an attribute value recommended to be added to the search query and a capability to narrow down each attribute value. An output attribute value is an attribute value effective for narrowing down registration information matching in a search in a case where an input search query is set.

The learning model is generated based on learning data indicating changes in the number of pieces of registration information matching in a search in a case of newly specifying a predetermined attribute value in a predetermined search query. An example of learning data will be described below.

For example, explanatory variables of learning data include a predetermined search query and information newly specified by the search query.

As described above, an attribute value and the certainty factor of the attribute value are set for at least one attribute in a “search query.” One attribute value may be specified, or a plurality of attribute values may be specified in a search query.

“Information newly specified by a search query” includes at least one attribute value and the certainty factor of the attribute value. Information newly specified by a search query may include one attribute value and the certainty factor of the attribute value. In addition, information newly specified by a search query may include a plurality of attribute values and the certainty factors of the respective attribute values.

A response variable of learning data represents a capability to narrow down a search result in a case where new information is specified in a predetermined search query.

For example, the narrowing-down capability may be indicated based on “(A) the number of pieces of registration information included in a search result of a search performed with a predetermined search query” and “(B) the number of pieces of registration information included in a search result of a search performed with the predetermined search query with newly specified information.” For example, the value of (A)−(B) may be set to be the narrowing-down capability. A greater value of the aforementioned value means a higher narrowing-down capability. In addition, the value of (B)/(A) may be set to be the narrowing-down capability. A smaller value of the aforementioned value means a higher narrowing-down capability. Further, a value equivalent to the aforementioned values may be set to be the narrowing-down capability.

In addition, the narrowing-down capability may be indicated based on “(A′) the rank of the degree of matching of a predetermined person in a search performed with a predetermined search query” and “(B′) the rank of the degree of matching of the predetermined person in a search performed with the predetermined search query with newly specified information.” For example, the value of (A′)−(B′) may be set to be the narrowing-down capability. A greater value of the aforementioned value means a higher narrowing-down capability. In addition, the value of (B′)/(A′) may be set to be the narrowing-down capability. A smaller value of the aforementioned value means a higher narrowing-down capability. Further, a value equivalent to the aforementioned values may be set to be the narrowing-down capability. The values each represent an amount of rise in the rank of the degree of matching of a predetermined person by specification of new information in the predetermined search query.

Explanatory variables of learning data can be created as follows. First, a plurality of patterns of search queries are created while changing the numbers of attribute values and certainty factors to be specified by a predetermined search query and the contents of the attribute values and the certainty factors. Further, a plurality of patterns of information (additional information) are created while changing the numbers of attribute values and certainty factors to be newly specified by a search query and the contents of the attribute values and certainty factors. Then, by combining the plurality of patterns of search queries and the plurality of patterns of information in every pattern, a plurality of patterns of a combination of “a predetermined search query” and “information newly specified by a search query” (explanatory variables) are created.

Then, by actually performing a search by using the explanatory variables, the aforementioned response variable is acquired. Note that, in a case where the narrowing-down capability indicated based on (A′) and (B′) described above is used, changes in the rank of the degree of matching can be tracked while changing a predetermined person the rank of whom is referred to.

Note that learning data created by the aforementioned creation method represents a narrowing-down capability in a case of adding one or a plurality of combinations of an attribute value and a certainty factor to a certain search query once. For example, in a case where a search query is “thirties: 70%,” the learning data represents a narrowing-down capability in a case of adding “male: 100%” to the search query or a narrowing-down capability in a case of adding “male: 90%” to the search query.

As another example, learning data representing a narrowing-down capability at each time in a case of adding one or a plurality of combinations of an attribute value and a certainty factor to a certain search query two or more times may be generated. For example, learning data may represent a narrowing-down capability in a case of adding “male: 100%” to a search query “thirties: 70%,” and a narrowing-down capability in a case of further adding “wearing glasses: 80%.”

Note that “a search query set at that point in time” may read as “a corrected search query set at that point in time” in the candidate determination processing example 5.

Processing of Determining an Attribute or an Attribute Value Recommended to be Specified by a Search Query from Among the Aforementioned Candidates, Based on at Least One of a Corrected Search Query and Reference Information

Processing based on a corrected search query (a recommended contents determination processing example 1) and processing based on reference information (a recommended contents determination processing example 2) will be described below.

### Recommended Contents Determination Processing Example 1: Processing of Determining a Recommended Attribute or Attribute Value from Among Candidates, Based on a Corrected Search Query

The recommendation unit 14 can determine an attribute or an attribute value not included in a corrected search query as an attribute or an attribute value recommended to be specified by a search query.

As described above, the correction unit 12 generates a corrected search query by adding a predetermined attribute value to a search query. The recommendation unit 14 excludes an attribute or an attribute value already added to the search query by correction by the correction unit 12 from an attribute or an attribute value recommended to be specified by the search query. Then, the recommendation unit 14 determines an attribute or an attribute value not included in the corrected search query as an attribute or an attribute value recommended to be specified by the search query.

For example, the recommendation unit 14 may determine every attribute or attribute value not included in the corrected search query out of candidates as an attribute or an attribute value recommended to be specified by the search query. In addition, the recommendation unit 14 may determine, by any means (e.g., the following recommended contents determination processing example 2), an attribute or an attribute value recommended to be specified by the search query from among attributes or attribute values not included in the corrected search query out of the candidates.

### Recommended Contents Determination Processing Example 2: Processing of Determining a Recommended Attribute or Attribute Value Out of Candidates, Based on Reference Information

The recommendation unit 14 determines an attribute value recommended to be specified by a search query, based on “a capability to narrow down the number of pieces of registration information matching in a search performed with the search query in which the registration information is newly specified, the capability being computed for each attribute value” and “the possibility of confusion indicated in reference information.”

The “narrowing-down capability” is a narrowing-down capability described in the aforementioned “candidate determination processing example 5: processing of determining a candidate of a recommended attribute or attribute value, based on a search query set at that point in time.”

The processing will be described by using a specific example. It is assumed that recommended candidates include three attribute values being “thirties,” “wearing red trousers,” and “carrying a backpack.” Then, it is assumed that the narrowing-down capability of “thirties” is 0.3, the narrowing-down capability of “wearing red trousers” is 0.9, and the narrowing-down capability of “carrying a backpack” is 0.7. Note that the narrowing-down capability herein takes on a value between 0 and 1 and is normalized in such a way that the narrowing-down capability increases as the value increases.

According to the reference information in FIG. 3, the possibility of thirties being confused with another attribute value is 0.41 (=20%+14%+7%). Then, while not being indicated in FIG. 3, it is assumed that the possibility of “wearing red trousers” being confused with another attribute value is 0.3, and the possibility of “carrying a backpack” being confused with another attribute value is 0.1.

The recommendation unit 14 computes an integrated score for each attribute value, based on such a possibility for each attribute value of a candidate and the narrowing-down capability. Then, the recommendation unit 14 determines an attribute value the integrated score of which satisfies a predetermined condition as a recommended attribute value.

For example, the integrated score may be the sum or the product of the aforementioned possibility and the aforementioned narrowing-down capability. In addition, the integrated score may be the sum of values acquired by multiplying the aforementioned possibility and the aforementioned narrowing-down capability by weights, respectively. In such a case, a higher integrated score is computed as the aforementioned possibility and the aforementioned narrowing-down capability increase.

The predetermined condition for an integrated score is an attribute value the integrated score of which is equal to or greater than a reference value, an attribute value the integrated score of which is included within a predetermined number from the top, or an attribute value the integrated score of which is included within a predetermined ratio from the top. Note that the above is based on the premise that a higher integrated score is computed as the aforementioned possibility and the aforementioned narrowing-down capability increase as described above.

As a modified example, the recommendation unit 14 may be designed in such a way that a lower integrated score is computed as the aforementioned possibility and the aforementioned narrowing-down capability increase. In this case, the predetermined condition for an integrated score is an attribute value the integrated score of which is equal to or less than a reference value, an attribute value the integrated score of which is included within a predetermined number from the bottom, or an attribute value the integrated score of which is included within a predetermined ratio from the bottom.

As described above, the recommendation unit 14 can determine and output an attribute recommended to be specified by a search query. In this case, for example, the recommendation unit 14 can output information for making an inquiry about an attribute value of a predetermined attribute, such as “What is the gender of the inspection target?” or “What is the age of the search target?” The recommendation unit 14 may recommend one attribute at a time or may recommend a plurality of attributes at a time.

Further, as described above, the recommendation unit 14 can determine and output an attribute value recommended to be specified by a search query. In this case, for example, the recommendation unit 14 can output information for making an inquiry about whether to include a predetermined attribute value in a search query such as “Add gender: male to the search query?” or “Add wearing glasses to the search query?” The recommendation unit 14 may recommend one attribute value at a time or may recommend a plurality of attribute values at a time. In a case of recommending a plurality of attribute values at a time, the recommendation unit 14 may recommend the plurality of attribute values separately. In addition, the recommendation unit 14 may recommend inclusion of a plurality of attribute values in a state of being combined by a predetermined logical operator (an AND condition or an OR condition) into a search query. Examples of this case include “Add gender: male AND wearing glasses to the search query?”

Next, the timing at which the recommendation unit 14 outputs recommended information will be described. The recommendation unit 14 can output an attribute or an attribute value recommended to be specified by a search query in a state of the search query being set.

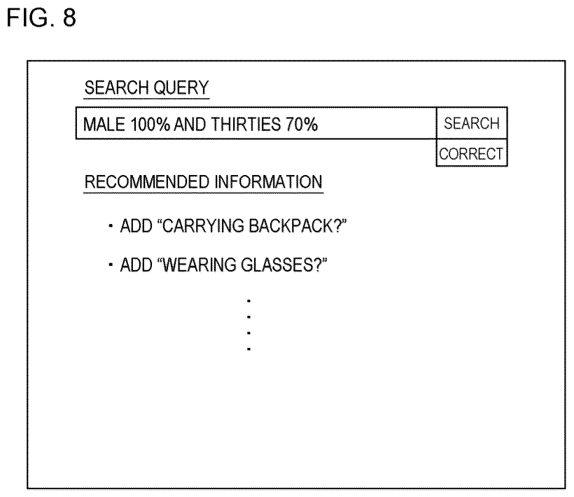

FIG. 8 illustrates an example of information output to a user. The illustrated screen includes a search query field and a recommendation information field.

A UI component for inputting a search query is displayed in the search query field. “An attribute or an attribute value recommended to be specified by the search query” output by the recommendation unit 14 is indicated in the recommendation information field. Attribute values recommended to be specified by the search query are indicated in the recommendation information field in the example in FIG. 8.

Information is input to the UI component for inputting a search query in the example in FIG. 8. Specifically, a search query is set. In a state of such a search query being set, attributes or attribute values recommended to be specified by the search query are output in the example in FIG. 8. For example, recommendation information as illustrated may be displayed at the timing of information being input to the UI component for inputting a search query and a search query being set.

Further, a correction button for automatically correcting a search query is displayed in the example in FIG. 8. The display of the search query field is switched from the search query set by a user to the aforementioned corrected search query in response to depression of the correction button. For example, the recommendation information as illustrated may be displayed at the timing when a corrected search query is displayed. Further, in a case where recommendation information is displayed prior to display of a corrected search query, the contents of the recommendation information may be updated at the timing of display of the corrected search query. Note that the configuration of displaying a corrected search query in response to depression of the correction button is strictly an example, and the display of the search query field may be switched from a search query set by a user to the aforementioned corrected search query at another timing.

Note that while not being illustrated, a UI component for accepting input of the aforementioned related information (e.g., the purpose of the search) may be displayed. Then, related information may be input in a state of a search query being set. Then, an attribute or an attribute value determined based on the related information may be output as an attribute or an attribute value recommended to be specified by the search query. Further, the contents of the recommendation information field may be updated in response to input of the related information.

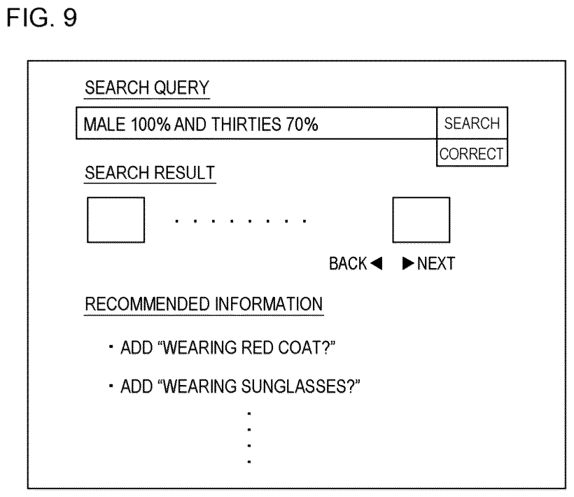

FIG. 9 illustrates another example of information output to a user. The illustrated screen includes a search query field, a search result field, and a recommendation information field.

A UI component for inputting a search query is displayed in the search query field. Registration information matching the search query is displayed in the search result field. “An attribute or an attribute value recommended to be specified by the search query” output by the recommendation unit 14 is indicated in the recommendation information field. Attribute values recommended to be specified by the search query are indicated in the recommendation information field in the example in FIG. 9.

Information is input to the UI component for inputting a search query in the example in FIG. 9. Specifically, a search query or a corrected search query is set. Then, a search result based on the search query or the corrected search query is displayed in the example in FIG. 9. Attributes or attribute values recommended to be specified by the search query are output in a state of such a search query or corrected search query being set and a search result being displayed in the example in FIG. 9. For example, the recommendation information as illustrated may be displayed at the timing of information being input to the UI component for inputting a search query, a search being performed, and the search result being displayed.

Note that while not being illustrated, a UI component for accepting input of the aforementioned related information (e.g., the purpose of the search) may be displayed. Then, related information may be input in a state of a search query being set and a search result being displayed. Then, an attribute or an attribute value determined based on the related information may be output as an attribute or an attribute value recommended to be specified by the search query. Further, the contents of the recommendation information field may be updated in response to input of the related information.

A user can determine an attribute or an attribute value to be newly added to a search query, based on the recommendation information as described above. Note that a certainty factor is to be set by a user himself/herself due to the characteristic of a certainty factor.

Next, an example of a flow of processing in the search apparatus 10 will be described.

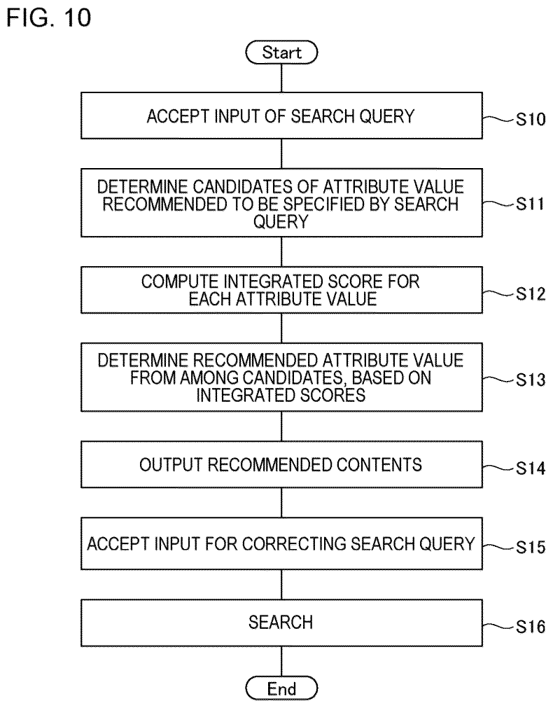

First, an example of a flow of processing of determining recommended contents in the processing in the aforementioned recommended contents determination processing example 2 will be described by using a flowchart in FIG. 10.

First, the search apparatus 10 accepts a search query specifying an attribute value and the certainty factor of the attribute value for at least one attribute (S10). Next, the search apparatus 10 determines candidates of an attribute value recommended to be specified by the search query (S11). The search apparatus 10 can determine the candidates by one of the aforementioned candidate determination processing examples 1 to 5.

Next, the search apparatus 10 computes an integrated score for each candidate attribute value (S12) and determines an attribute value recommended to be specified by the search query from among the candidates, based on the computed integrated scores (S13). Details of the processing in S12 and S13 are described above as the recommended contents determination processing example 2.

Next, the search apparatus 10 outputs the recommended contents determined in S13 (S14). Subsequently, the search apparatus 10 accepts input for correcting the search query (S15) and performs a search by using the corrected search query (S16).

Note that the search apparatus 10 may generate a corrected search query by correcting the search query, based on the aforementioned reference information (see FIG. 3) after S10. Then, the search apparatus 10 may subsequently perform the processing in S11 to S16. In this case, the determination of candidates in S11 is made based on the corrected search query.

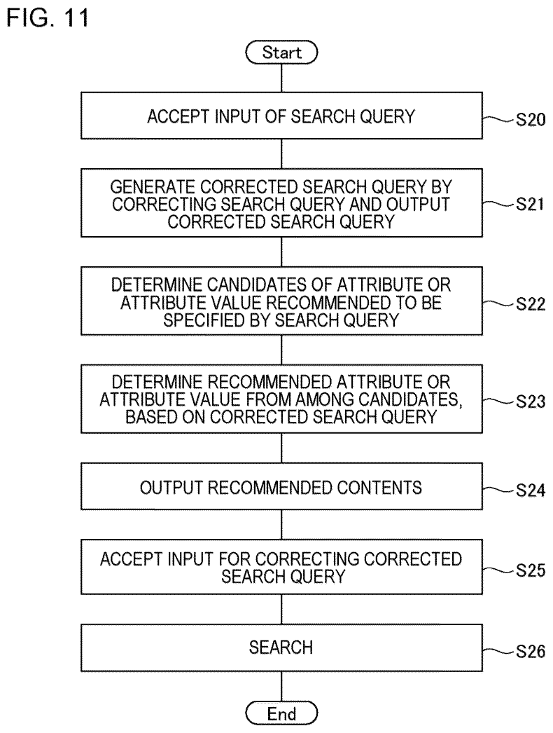

Next, an example of a flow of processing of determining recommended contents in the processing of the aforementioned recommended contents determination processing example 1 will be described by using a flowchart in FIG. 11.

First, the search apparatus 10 accepts a search query specifying an attribute value and the certainty factor of the attribute value for at least one attribute (S20). Next, the search apparatus 10 generates a corrected search query by correcting the accepted search query, based on the aforementioned reference information (see FIG. 3), and outputs the corrected search query (S21).

Further, the search apparatus 10 determines candidates of an attribute or an attribute value recommended to be specified by the search query (S22). The search apparatus 10 can determine the candidates by one of the aforementioned candidate determination processing examples 1 to 5. Note that the processing order of S21 and S22 is not limited to the example illustrated in the flowchart in FIG. 11.

Next, the search apparatus 10 determines an attribute or an attribute value recommended to be specified by the search query from among the candidates, based on the corrected search query generated in S21 (S23). Details of the processing in S23 are described above as the recommended contents determination processing example 1.

Next, the search apparatus 10 outputs the recommended contents determined in S23 (S24). Subsequently, the search apparatus 10 accepts input for correcting the search query (S25) and performs a search by using the corrected search query (S26).

### Advantageous Effect

For example, in a case where a search query is set based on a vague memory of a user or in a case where a search query is set based on contents heard from another person, an attribute value of a search target may be confused within a certain range and an incorrect search query may be set. The search apparatus 10 according to the second example embodiment generates a corrected search query by adding an attribute value that may be confused with an attribute value set by a search query to the search query. According to such a search apparatus 10 according to the second example embodiment, a correct attribute value is included in the corrected search query even in a case where an incorrect search query is set due to confusion, and therefore, a search for a desired search target may be performed.

Further, based on the possibility of each attribute value specified by a search query being confused with each of other attribute values, the search apparatus 10 according to the second example embodiment can determine the certainty factor of another attribute value in a corrected search query. Such a search apparatus 10 according to the second example embodiment enables suitable setting of the certainty factor of another attribute value in a corrected search query. As a result, search precision is improved.

Further, the search apparatus 10 according to the second example embodiment can set an attribute value the certainty factor of which is less than a reference value as a correction target and exclude an attribute value the certainty factor of which is equal to or greater than the reference value from a correction target. Unnecessary correction of an attribute value confidently set by a user unnecessarily increases the processing load of the computer. Setting an attribute value the certainty factor of which is less than the reference value to be a correction target and excluding an attribute value the certainty factor of which is equal to or greater than the reference value from a correction target enables mitigation of the inconvenience.

Further, the search apparatus 10 according to the second example embodiment can determine and output an attribute or an attribute value recommended to be specified by a search query by characteristic processing. A user can suitably correct a search query, based on the recommendation information.

### Third Example Embodiment

A search apparatus 10 according to a third example embodiment varies the way an attribute value specified by a search query is corrected, according to the certainty factor of each attribute value specified by the search query in processing of generating a corrected search query. The possibility of occurrence of confusion is considered low in a case where a certainty factor is high, whereas the possibility of occurrence of confusion is considered high in a case where a certainty factor is low. In consideration of such a point, the search apparatus 10 according to the third example embodiment varies the way an attribute value specified by a search query is corrected, according to the certainty factor of the attribute value specified by the search query. Details will be described below.

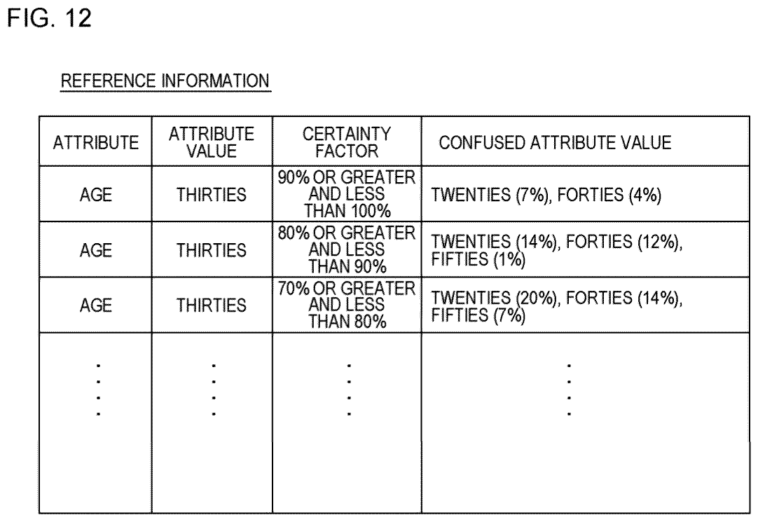

A correction unit 12 can generate a corrected search query from a search query, based on reference information as illustrated in FIG. 12.

The reference information illustrated in FIG. 12 indicates “other attribute values that may be confused with each attribute value” and “the possibility of the attribute value being confused with each of the other attribute values” in a case where a certainty factor specified by a search query falls within a predetermined range. One attribute value is determined by the values of an “attribute” field and an “attribute value” field. The certainty factor of one determined attribute value is indicated in a “certainty factor” field. Then, a “confused attribute value” field indicates other attribute values that may be confused with the one attribute value determined by the values of the “attribute” field and the “attribute value” field in a case where the certainty factor falls within a range indicated by the value of the “certainty factor” field. Note that a numerical value associated with each attribute value indicated in the “confused attribute value” field indicates the possibility of each attribute value being confused with each of other attribute values.

In a case where “thirties” and a certainty factor being “90% or greater and less than 100%” are specified in a search query, the reference information illustrated in FIG. 12 indicates that the search target person may actually be in twenties or forties. Furthermore, the reference information illustrated in FIG. 12 indicates the possibility (7%) of the search target person actually being in twenties and the possibility (4%) of being in forties.

Further, in a case where “thirties” and a certainty factor being “80% or greater and less than 90%” are specified in a search query, the reference information illustrated in FIG. 12 indicates that the search target person may actually be in twenties, forties, or fifties. Furthermore, the reference information illustrated in FIG. 12 indicates the possibility (14%) of the search target person actually being in twenties, the possibility (12%) of being in forties, and the possibility (1%) of being in fifties.

Such reference information can be generated by any means. For example, an administrator of the search apparatus 10 (a person in charge at the manufacturer) gets a plurality of subjects to view a person in each age group and gets each subject to answer the age of the person assumed by the subject and the certainty factor of the age. Then, the administrator of the search apparatus 10 can generate reference information as illustrated in FIG. 12 by compiling the answer results. Note that the administrator of the search apparatus 10 may perform the experiment under a varied condition. For example, the administrator of the search apparatus 10 may get a plurality of subjects to view a person in each age group without telling details and get each subject to answer the age of the person assumed by the subject and the certainty factor of the age after a lapse of a certain time (e.g., after several days). As another example of the way reference information is generated, the administrator of the search apparatus 10 may generate reference information as illustrated in FIG. 12, based on experience and sense of the administrator. Note that the way reference information is generated exemplified above is strictly an example and is not limited thereto.

A specific example of processing of correcting a search query, based on the reference information illustrated in FIG. 12, will be described.

For example, the correction unit 12 can generate a corrected search query described below from a search query described below, based on the reference information illustrated in FIG. 12. Twenties: 14%, forties: 10%, and fifties: 6% are given to the search query by using AND conditions in the following correction.

(search query) “male: 100% AND thirties: 70% AND wearing red trousers: 100%”
(corrected search query) “male: 100% AND thirties: 70% AND twenties: 14% AND forties: 10% AND fifties: 6% AND wearing red trousers: 100%”

In a case where thirties included in the search query is set to be a correction target, the correction unit 12 generates a corrected search query, based on a confused attribute value associated with an attribute value: thirties and a certainty factor equal to or greater than 70% and less than 80% in the reference information illustrated in FIG. 12. A specific method of generating a corrected search query is similar to that according to the second example embodiment.

As described above, based on reference information as illustrated in FIG. 12, and an attribute value and a certainty factor that are set by a search query, the correction unit 12 determines another attribute value (a second attribute value) to be included in a corrected search query and the certainty factor of the attribute value. In a case where the certainty factor of an attribute value set by a search query satisfies a predetermined condition, the reference information illustrated in FIG. 12 indicates another attribute value that may be confused with the attribute value and the possibility of the confusion.

The remaining configuration of the search apparatus 10 according to the third example embodiment is similar to the configurations of the search apparatuses 10 according to the first and second example embodiments.

The search apparatus 10 according to the third example embodiment achieves advantageous effects similar to those achieved by the search apparatuses 10 according to the first and second example embodiments. Further, the search apparatus 10 according to the third example embodiment can vary the way an attribute value specified by a search query is corrected, according to the certainty factor of each attribute value specified by the search query. The possibility of occurrence of confusion is considered low in a case where a certainty factor is high, whereas the possibility of occurrence of confusion is considered high in a case where a certainty factor is low. Search precision is improved by generating a corrected search query by suitably correcting each attribute value specified by a search query in consideration of such a point.

### Fourth Example Embodiment

A search apparatus 10 according to a fourth example embodiment varies the way an attribute value specified by a search query is corrected, according to an attribute of “an eyewitness sighting a search target and providing an attribute value to be included in a search query” in processing of generating a corrected search query.

Existence of confusion and the way confusion occurs may vary according to an attribute of an eyewitness. For example, in a case where an eyewitness is a child, the possibility of the age of a search target in twenties to forties being confused is higher compared with a case of the eyewitness being an adult. Further, the possibility of the age of a search target being confused is higher with an eyewitness of nationality different from that of the search target compared with an eyewitness of the same nationality as that of the search target. Further, the possibility of features of clothing and belongings of a search target being confused is higher with an eyewitness of gender different from that of the search target compared with an eyewitness of the same gender as that of the search target. Further, the possibility of features of clothing and belongings of a search target being confused is higher with an eyewitness of taste for fashion different from that of the search target compared with an eyewitness of the same taste for fashion as that of the search target.

In consideration of such a point, the search apparatus 10 according to the fourth example embodiment varies the way an attribute value specified by a search query is corrected, according to an attribute of “an eyewitness sighting a search target and providing an attribute value to be included in the search query.” Details will be described below.

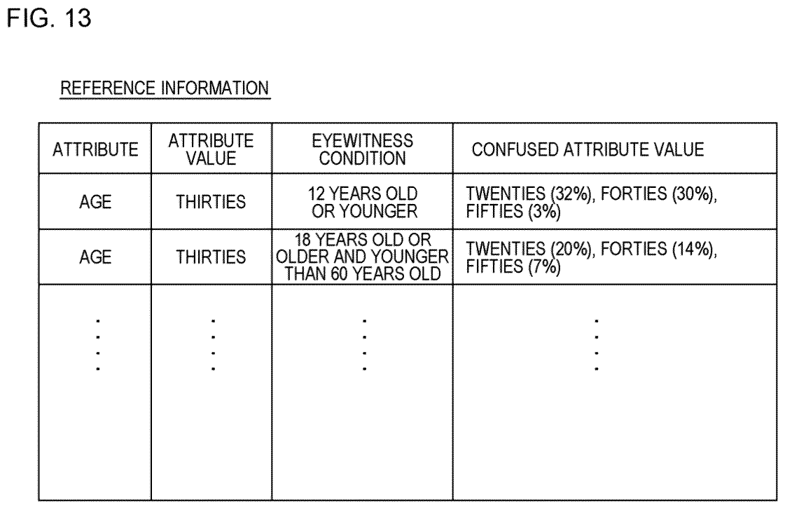

A correction unit 12 can generate a corrected search query from a search query, based on reference information as illustrated in FIG. 13.

The reference information illustrated in FIG. 13 indicates “other attribute values that may be confused with each attribute value being set based on eyewitness evidence of an eyewitness satisfying a predetermined eyewitness condition” and “the possibility of the attribute value being confused with each of the other attribute values.” One attribute value is determined by the values of an “attribute” field and an “attribute value” field.

A condition for an eyewitness is indicated in an “eyewitness condition” field. The condition for an eyewitness is defined by using gender, age, nationality, a hairstyle, a feature of clothing, a feature of belongings, and the like.

Then, in a case of an eyewitness satisfying the predetermined eyewitness condition, the “confused attribute value” field indicates other attribute values that may be confused with one attribute value determined by the values of the “attribute” field and the “attribute value” field. Note that a numerical value associated with each attribute value indicated in the “confused attribute value” field indicates the possibility of occurrence of confusion.

In a case where an eyewitness is “12 years old or younger,” and “thirties” is set in a search query, the reference information illustrated in FIG. 13 indicates that the search target person may actually be in twenties, forties, or fifties. Furthermore, the reference information illustrated in FIG. 13 indicates the possibility (32%) of the search target person actually being in twenties, the possibility (30%) of being in forties, and the possibility (3%) of being in fifties.

Further, in a case where an eyewitness is “18 years old or older and younger than 60 years old,” and “thirties” is set in a search query, the reference information illustrated in FIG. 13 indicates that the search target person may actually be in twenties, forties, or fifties. Furthermore, the reference information illustrated in FIG. 13 indicates the possibility (20%) of the search target person actually being in twenties, the possibility (14%) of being in forties, and the possibility (7%) of being in fifties.

Such reference information can be generated by any means. For example, an administrator of the search apparatus 10 (a person in charge at the manufacturer) gets a plurality of subjects to view a person in each age group and get each subject to answer the age of the person assumed by the subject. Then, the administrator of the search apparatus 10 can generate reference information as illustrated in FIG. 13 by compiling the answer results for each attribute of an eyewitness. Note that the administrator of the search apparatus 10 may perform the experiment under a varied condition. For example, the administrator of the search apparatus 10 may get a plurality of subjects to view a person in each age group without telling details and get each subject to answer the age of the person assumed by the subject after a lapse of a certain time (e.g., after several days). As another example of the way reference information is generated, the administrator of the search apparatus 10 may generate reference information as illustrated in FIG. 13, based on experience and sense of the administrator. Note that the way reference information is generated exemplified above is strictly an example and is not limited thereto.

A specific example of processing of correcting a search query, based on the reference information illustrated in FIG. 13, will be described.

First, the input acceptance unit 11 accepts input of setting an attribute of an eyewitness in addition to a search query. Specifically, a user inputs an attribute of an eyewitness to the search apparatus 10.

For example, the correction unit 12 can generate a corrected search query described below from a search query described below, based on the reference information illustrated in FIG. 13. Twenties: 14%, forties: 10%, and fifties: 6% are given to the search query by using AND conditions in the following correction.

(search query) “male: 100% AND thirties: 70% AND wearing red trousers: 100%”
(corrected search query) “male: 100% AND thirties: 70% AND twenties: 14% AND forties: 10% AND fifties: 6% AND wearing red trousers: 100%”

For example, it is assumed that an input attribute of an eyewitness is 40 years old. Then, in a case where thirties included in the search query is a correction target, the correction unit 12 generates a corrected search query, based on a confused attribute value associated with an attribute value: thirties and an eyewitness condition: 18 years old or older and younger than 60 years old in the reference information illustrated in FIG. 13. A specific method of generating a corrected search query is similar to that according to the second example embodiment.

As described above, based on a set attribute of an eyewitness, reference information as illustrated in FIG. 13, and an attribute value and a certainty factor that are set by a search query, the correction unit 12 determines another attribute value (a second attribute value) to be included in a corrected search query and the certainty factor of the attribute value. The reference information illustrated in FIG. 13 indicates other attribute values that may be confused with each attribute value and the possibility of the confusion in a case where an attribute of the eyewitness satisfies a predetermined eyewitness condition.

The remaining configuration of the search apparatus 10 according to the fourth example embodiment is similar to the configurations of the search apparatuses 10 according to the first to third example embodiments.

The search apparatus 10 according to the fourth example embodiment achieves advantageous effects similar to those achieved by the search apparatuses 10 according to the first to third example embodiments. Further, the search apparatus 10 according to the fourth example embodiment can vary the way an attribute value specified by a search query is corrected, according to an attribute of “an eyewitness sighting a search target and providing an attribute value to be included in the search query.”

Existence of confusion and the way confusion occurs may vary according to an attribute of an eyewitness. For example, in a case where an eyewitness is a child, the possibility of the age of a search target in twenties to forties being confused is higher compared with a case of the eyewitness being an adult. Further, the possibility of the age of a search target being confused is higher with an eyewitness of nationality different from that of the search target compared with an eyewitness of the same nationality as that of the search target. Further, the possibility of features of clothing and belongings of a search target being confused is higher with an eyewitness of gender different from that of the search target compared with an eyewitness of the same gender as that of the search target. Further, the possibility of features of clothing and belongings of a search target being confused is higher with an eyewitness of taste for fashion different from that of the search target compared with an eyewitness of the same taste for fashion as that of the search target.

Search precision is improved by generating a corrected search query by suitably correcting each attribute value specified by a search query in consideration of such a point.

### Fifth Example Embodiment

A search apparatus 10 according to a fifth example embodiment varies the way an attribute value specified by a search query is corrected, according to an environment at the time when a search target was sighted in processing of generating a corrected search query.

Existence of confusion and the way confusion occurs may vary according to an environment at sighting. For example, the way a target object appears and the way color appears may vary according to a timing such as nighttime, evening, daytime, or morning. Further, the way a target object appears and the way color appears may vary according to the weather such as sunny weather, rain, or cloudy weather. Further, the way a target object appears and the way color appears may vary between outdoors and indoors. Further, the possibility of an attribute of a target object being confused may increase in a case where there are many persons in the surroundings, whereas the possibility of an attribute of a target object being confused may decrease in a case where there are few or no persons in the surroundings.

In consideration of such a point, the search apparatus 10 according to the fifth example embodiment varies the way an attribute value specified by a search query is corrected, according to an environment at the time when a search target was sighted. Details will be described below.

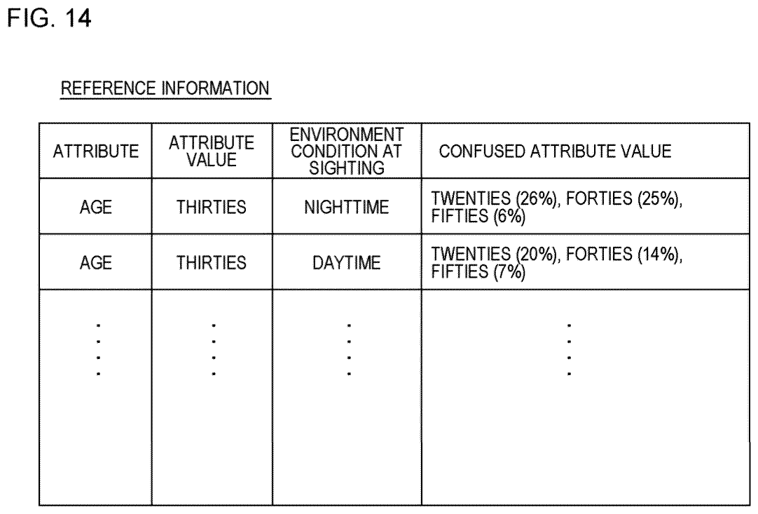

A correction unit 12 can generate a corrected search query from a search query, based on reference information as illustrated in FIG. 14.

The reference information illustrated in FIG. 14 indicates “other attribute values that may be confused with each attribute value being set based on a sighting in an environment satisfying a predetermined environment condition at sighting” and “the possibility of the attribute value being confused with each of the other attribute values.” One attribute value is determined by the values of an “attribute” field and an “attribute value” field.

A condition for an environment at sighting is indicated in an “environment condition at sighting” field. The condition for an environment at sighting is defined by using a time period, daytime or nighttime, indoors or outdoors, whether many persons exist in the surroundings, and the like.

Then, in a case where the environment satisfies a predetermined environment condition at sighting, a “confused attribute value” field indicates other attribute values that may be confused with one attribute value determined by the values of the “attribute” field and the “attribute value” field. Note that a numerical value associated with each attribute value indicated in the “confused attribute value” field indicates the possibility of confusion.

In a case where the environment at sighting is “nighttime,” and “thirties” is set in a search query, the reference information illustrated in FIG. 14 indicates that the search target person may actually be in twenties, forties, of fifties. Furthermore, the reference information illustrated in FIG. 14 indicates the possibility (26%) of the search target person actually being in twenties, the possibility (25%) of being in forties, and the possibility (6%) of being in fifties.

Further, in a case where the environment at sighting is “daytime,” and “thirties” is set in a search query, the reference information illustrated in FIG. 14 indicates that the search target person may actually be in twenties, forties, or fifties. Furthermore, the reference information illustrated in FIG. 14 indicates the possibility (20%) of the search target person actually being in twenties, the possibility (14%) of being in forties, and the possibility (7%) of being in fifties.

Such reference information can be generated by any means. For example, an administrator of the search apparatus 10 (a person in charge at the manufacturer) gets a plurality of subjects to view a person in each age group in a predetermined environment and gets each subject to answer the age of the person assumed by the subject. Then, the administrator of the search apparatus 10 can generate reference information as illustrated in FIG. 14 by compiling the answer results for each environment. Note that the administrator of the search apparatus 10 may perform the experiment under a varied condition. For example, the administrator of the search apparatus 10 may get a plurality of subjects to view a person in each age group in the predetermined environment without telling details and get each subject to answer the age of the person assumed by the subject after a lapse of a certain time (e.g., after several days). As another example of the way reference information is generated, the administrator of the search apparatus 10 may generate reference information as illustrated in FIG. 14, based on experience and sense of the administrator. Note that the way reference information is generated exemplified above is strictly an example and is not limited thereto.

A specific example of processing of correcting a search query, based on the reference information illustrated in FIG. 14, will be described.

First, an input acceptance unit 11 accepts input of setting an environment at sighting in addition to a search query. Specifically, a user inputs an environment at sighting to the search apparatus 10.

For example, the correction unit 12 can generate a corrected search query described below from a search query described below, based on the reference information illustrated in FIG. 14. Twenties: 14%, forties: 10%, and fifties: 6% are given to the search query by using AND conditions in the following correction.

(search query) “male: 100% AND thirties: 70% AND wearing red trousers: 100%”
(corrected search query) “male: 100% AND thirties: 70% AND twenties: 14% AND forties: 10% AND fifties: 6% AND wearing red trousers: 100%”

For example, it is assumed that an input environment at sighting is daytime. In a case where thirties included in the search query is set to be a correction target, the correction unit 12 generates a corrected search query, based on a confused attribute value associated with an attribute value: thirties and an environment condition at sighting: daytime in the reference information illustrated in FIG. 14. A specific method of generating a corrected search query is similar to that according to the second example embodiment.

As described above, based on a set environment at sighting, reference information as illustrated in FIG. 14, and an attribute value and a certainty factor that are set by a search query, the correction unit 12 determines another attribute value (a second attribute value) to be included in a corrected search query and the certainty factor of the attribute value. In a case where the environment at sighting satisfies the predetermined environment condition at sighting, the reference information illustrated in FIG. 14 indicates another attribute value that may be confused with each attribute value and the possibility of the confusion.

The remaining configuration of the search apparatus 10 according to the fifth example embodiment is similar to the configurations of the search apparatuses 10 according to the first to fourth example embodiments.

The search apparatus 10 according to the fifth example embodiment achieves advantageous effects similar to those achieved by the search apparatuses 10 according to the first to fourth example embodiments. Further, the search apparatus 10 according to the fifth example embodiment can vary the way an attribute value specified by a search query is corrected, according to an environment at the time when the search target was sighted.

Existence of confusion and the way confusion occurs may vary according to an environment at sighting. For example, the way a target object appears and the way color appears may vary according to a timing such as nighttime, evening, daytime, or morning. Further, the way a target object appears and the way color appears may vary according to the weather such as sunny weather, rain, or cloudy weather. Further, the way a target object appears and the way color appears may vary between outdoors and indoors. Further, the possibility of an attribute of a target object being confused may increase in a case where there are many persons in the surroundings, whereas the possibility of an attribute of a target object being confused may decrease in a case where there are few or no persons in the surroundings.

Search precision is improved by generating a corrected search query by suitably correcting each attribute value specified by a search query in consideration of such a point.

### Sixth Example Embodiment

A search apparatus 10 according to a sixth example embodiment varies the way an attribute value specified by a search query is corrected, according to another attribute value specified by the search query in processing of generating a corrected search query.

As an example, a feature of clothing specified by a search query can be used in correction of the age of a search target. For example, in a case where “wearing a miniskirt” is set in a search query, the age of the search target person is narrowed down to some extent according to a feature of the miniskirt. Further, the way of narrowing down is preferably varied depending on whether the certainty factor of an attribute value is set high in a search query.

In consideration of such a point, the search apparatus 10 according to the sixth example embodiment varies the way an attribute value specified by a search query is corrected, according to another attribute value specified by the search query. Details will be described below. Note that, in order to distinguish “another attribute value” specified by a search query from “another attribute value” that may be confused with each attribute value, “another attribute value” specified by a search query is hereinafter referred to as a “simultaneously set attribute value.”

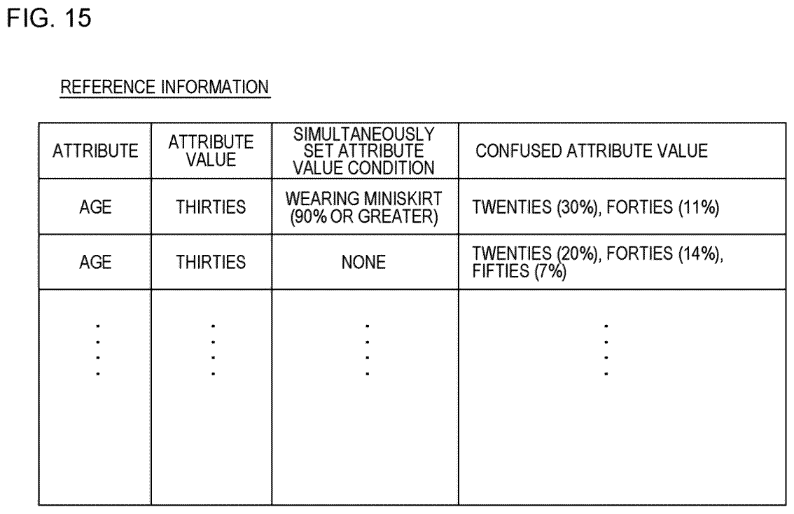

A correction unit 12 can generate a corrected search query from a search query, based on reference information as illustrated in FIG. 15.

In a case where a simultaneously set attribute value set with each attribute value satisfies a predetermined simultaneously set attribute value condition in a search query, the reference information illustrated in FIG. 15 indicates “other attribute values that may be confused with each attribute value” and “the possibility of the attribute value being confused with each of the other attribute values.” One attribute value is determined by the values in an “attribute” field and an “attribute value” field.

A condition related to a simultaneously set attribute value specified by the search query is indicated in a “simultaneously set attribute value condition” field. The simultaneously set attribute value condition is defined by contents such as what attribute value is included in the search query and what attribute value is included in the search query with what certainty factor. In addition, the simultaneously set attribute value condition may be defined by contents such as what attribute value is not included in the search query.

Then, in a case where the predetermined simultaneously set attribute value condition is satisfied, the “confused attribute value” field indicates other attribute values that may be confused with one attribute value determined by the values of the “attribute” field and the “attribute value” field. Note that a numerical value associated with each attribute value indicated in the “confused attribute value” field indicates the possibility of confusion.

In a case where “thirties” is set and “wearing a miniskirt” is further set with a certainty factor of 90% or greater in a search query, the reference information illustrated in FIG. 15 indicates that the search target person may actually be in twenties or forties. Furthermore, the reference information illustrated in FIG. 15 indicates the possibility (30%) of the search target person actually being in twenties and the possibility (11%) of being in forties.

Further, in a case where “thirties” is set and “wearing a miniskirt” is not set with a certainty factor of 90% or greater in the search query, the reference information illustrated in FIG. 15 indicates that the search target person may actually be in twenties, forties, or fifties. Furthermore, the reference information illustrated in FIG. 15 indicates the possibility (20%) of the search target person actually being in twenties, the possibility (14%) of being in forties, and the possibility (7%) of being in fifties.

Such reference information can be generated by any means. For example, an administrator of the search apparatus 10 (a person in charge at the manufacturer) gets a plurality of subjects to view a person in each age group and gets each subject to answer the age of the person assumed by the subject. Then, the administrator of the search apparatus 10 compiles the answer results. Further, the administrator of the search apparatus 10 (the person in charge at the manufacturer) compiles trends of attribute values of a plurality of randomly extracted subjects and computes the trends. Thus, the possibility of a person with each attribute value (e.g., twenties, thirties, or forties) with a predetermined attribute value (e.g., wearing a miniskirt), and the like can be computed. The administrator of the search apparatus 10 can generate reference information as illustrated in FIG. 15 by integrating the aforementioned compilation results by any technique. Note that the administrator of the search apparatus 10 may perform the experiment under a varied condition. For example, the administrator of the search apparatus 10 may get a plurality of subjects to view a person in each age group without telling details and get each subject to answer the age of the person assumed by the subject after a lapse of a certain time (e.g., after several days). As another example of the way reference information is generated, the administrator of the search apparatus 10 may generate reference information as illustrated in FIG. 15, based on experience and sense of the administrator. Note that the way reference information is generated exemplified above is strictly an example and is not limited thereto.

A specific example of processing of correcting a search query, based on the reference information illustrated in FIG. 15, will be described.

The correction unit 12 refers to the reference information illustrated in FIG. 15 and determines a “simultaneously set attribute value condition” satisfied by an attribute value being a correction target. Then, the correction unit 12 generates a corrected search query, based on a confused attribute value associated with the determined simultaneously set attribute value condition. A specific method of generating a corrected search query is similar to that according to the second example embodiment.

As described above, the correction unit 12 determines another attribute value (a second attribute value) to be included in a corrected search query and the certainty factor of the attribute value, based on reference information as illustrated in FIG. 15. The reference information illustrated in FIG. 15 indicates another attribute value that may be confused with each attribute value in a case where another attribute value specified by a search query satisfies the predetermined simultaneously set attribute value condition and the possibility of the confusion.

The remaining configuration of the search apparatus 10 according to the sixth example embodiment is similar to the configurations of the search apparatuses 10 according to the first to fifth example embodiments.

The search apparatus 10 according to the sixth example embodiment achieves advantageous effects similar to those achieved by the search apparatuses 10 according to the first to fifth example embodiments. Further, the search apparatus 10 according to the sixth example embodiment can vary the way an attribute value specified by a search query is corrected, according to another attribute value specified by the search query.

As an example, a feature of clothing specified by a search query can be used in correction of the age of a search target. For example, in a case where “wearing a miniskirt” is set in a search query, the age of the search target person is narrowed down to some extent according to a feature of the miniskirt. Further, the way of narrowing down is preferably varied depending on whether the certainty factor of an attribute value is set high in a search query.

Search precision is improved by generating a corrected search query by suitably correcting each attribute value specified by a search query in consideration of such a point.

### Seventh Example Embodiment

A search apparatus 10 according to a seventh example embodiment varies the way an attribute value set by a search query is corrected, according to the time elapsed from the timing at which a search target was sighted.

Existence of confusion and the way confusion occurs may vary according to the time elapsed from the timing at which a search target was sighted. In general, confusion is more likely to occur as the elapsed time increases. Further, the range of confusion increases as the elapsed time increases.

In consideration of such a point, the search apparatus 10 according to the seventh example embodiment varies the way an attribute value set in a search query is corrected, according to the time elapsed from the timing at which a search target was sighted. Details will be described below.

A correction unit 12 generates a corrected search query by correcting a search query, based on reference information specifying a plurality of patterns of confused attribute values based on the time elapsed from the timing at which a search target was sighted and the possibility of confusion. The way of correction is similar to those according to the aforementioned example embodiments. A user inputs the time elapsed from the timing at which a search target was sighted to the search apparatus 10.

Such reference information can be generated by any means. For example, an administrator of the search apparatus 10 (a person in charge at the manufacturer) gets a plurality of subjects to view a person in each age group in a predetermined environment and gets each subject to answer the age of the person assumed by the subject after a lapse of a predetermined time. The elapsed time is varied for each subject. Then, the administrator of the search apparatus 10 can generate reference information as described above by compiling the answer results for each elapsed time. As another example of the way reference information is generated, the administrator of the search apparatus 10 may generate reference information as described above, based on experience and sense of the administrator. Note that the way reference information is generated exemplified above is strictly an example and is not limited thereto.

The remaining configuration of the search apparatus 10 according to the seventh example embodiment is similar to the configurations of the search apparatuses 10 according to the first to sixth example embodiments.

The search apparatus 10 according to the seventh example embodiment achieves advantageous effects similar to those achieved by the search apparatuses 10 according to the first to sixth example embodiments. Further, the search apparatus 10 according to the seventh example embodiment can vary the way an attribute value set by a search query is corrected, according to the time elapsed from the timing at which a search target was sighted.

Existence of confusion and the way confusion occurs may vary according to the time elapsed from the timing at which a search target was sighted. In general, confusion is more likely to occur as the elapsed time increases. Further, the range of confusion increases as the elapsed time increases.

Search precision is improved by generating a corrected search query by suitably correcting each attribute value set by a search query in consideration of such a point.

### Eighth Example Embodiment

A search apparatus 10 according to an eighth example embodiment generates a corrected search query from a search query by a technique of combining a plurality of techniques described in the third to seventh example embodiments.

Specifically, the search apparatus 10 according to the eighth example embodiment varies the way an attribute value specified by a search query is corrected, according to at least two items out of “the certainty factor of each attribute value specified by the search query,” “an attribute of an eyewitness sighting a search target and providing an attribute value to be included in the search query,” “the environment at the time when the search target was sighted,” “another attribute value specified by the search query,” and “the time elapsed from the timing at which the search target was sighted.”

Specifically, in a case where a predetermined condition defined by using at least two out of the plurality of items as described above is satisfied, reference information indicates another attribute value that may be confused with each attribute and the possibility of the confusion. Then, a correction unit 12 generates a corrected search query from the search query by using the reference information.

The remaining configuration of the search apparatus 10 according to the eighth example embodiment is similar to the configurations of the search apparatuses 10 according to the first to seventh example embodiments. The search apparatus 10 according to the eighth example embodiment achieves advantageous effects similar to those achieved by the search apparatuses 10 according to the first to seventh example embodiments. Further, the possibility of each attribute value being confused with another attribute value can be defined in a more minutely classified manner. As a result, a corrected search query can be generated by more suitably correcting a search query.

### Ninth Example Embodiment

A search apparatus 10 according to a ninth example embodiment generates a corrected search query from a search query by using a learning model learning a trend of confusion as described in the aforementioned example embodiments.

Specifically, a correction unit 12 generates a corrected search query from a search query by using a learning model learning a trend of confusion as described in the aforementioned example embodiments.

For example, in response to input of an attribute value, a learning model outputs a confused attribute value that may be confused with the attribute value and the possibility of the confusion.

In addition, in response to input of an attribute value and the certainty factor of the attribute value, a learning model may output a confused attribute value that may be confused with the attribute value and the possibility of the confusion. The learning model is acquired by learning of a trend of confusion described in the third example embodiment.

In addition, in response to input of an attribute value and an attribute of an eyewitness, a learning model may output a confused attribute value that may be confused with the attribute value and the possibility of the confusion. The learning model is acquired by learning of a trend of confusion described in the fourth example embodiment.

In addition, in response to input of an attribute value and an environment at sighting, a learning model may output a confused attribute value that may be confused with the attribute value and the possibility of the confusion. The learning model is acquired by learning of a trend of confusion described in the fifth example embodiment.

In addition, in response to input of an attribute value and another attribute value set by a search query, a learning model may output a confused attribute value that may be confused with the attribute value and the possibility of the confusion. The learning model is acquired by learning of a trend of confusion described in the sixth example embodiment.

In addition, in response to input of an attribute value, and the time elapsed from the timing at which the search target was sighted, a learning model may output a confused attribute value that may be confused with the attribute value and the possibility of the confusion. The learning model is acquired by learning of a trend of confusion described in the seventh example embodiment.

In addition, in response to input of an “attribute value” and “at least two items out of the certainty factor of the attribute value, an attribute of an eyewitness, an environment at sighting, another attribute value set by a search query, and the time elapsed from the timing at which a search target was sighted,” a learning model may output a confused attribute value that may be confused with the attribute value and the possibility of the confusion. The learning model is acquired by learning of a trend of confusion described in the eighth example embodiment.

The remaining configuration of the search apparatus 10 according to the ninth example embodiment is similar to the configurations of the search apparatuses 10 according to the first to eighth example embodiments. The search apparatus 10 according to the ninth example embodiment achieves advantageous effects similar to those achieved by the search apparatuses 10 according to the first to eighth example embodiments.

### MODIFIED EXAMPLES

Modified examples applicable to all of the aforementioned example embodiments will be described below. The modified examples also achieve advantageous effects similar to those achieved by the aforementioned example embodiments.

### Modified Example 1

(search query) “thirties: 20% AND forties: 70%”

A plurality of attribute values may be set in association with one attribute in a search query as is the case with the aforementioned example. Two attribute values being thirties and forties are set in association with age in the aforementioned example.

In such a case, the correction unit 12 generates a corrected search query, based on the plurality of attribute values. Specifically, the correction unit 12 determines “an attribute value related to the attribute” and “the certainty factor of the attribute value” that are to be included in a corrected search query, based on the plurality of attribute values. In the case of the aforementioned example, the correction unit 12 determines an attribute value of age and the certainty factor of the attribute value that are to be included in the corrected search query, based on the two attribute values being thirties and forties.

There are various correction techniques. Examples of correcting the search query in the aforementioned example, based on the reference information in FIG. 3, will be described below.

### Example 1

As an example, the correction unit 12 may include all of other attribute values that may be confused with each of a plurality of attribute values set in a search query into a corrected search query.

Twenties, forties, and fifties are indicated in the reference information in FIG. 3 as other attributes that may be confused with thirties.

Further, the reference information in FIG. 3 indicates thirties and fifties as other attributes that may be confused with forties.

In the case of the example, the correction unit 12 includes all of twenties, forties, and fifties that may be confused with thirties, and thirties and fifties that may be confused with forties, and thirties and forties that are originally included in the search query into the corrected search query.

There are various ways to set a certainty factor. For example, the correction unit 12 may set a statistical value of certainty factors of each attribute value set by a search query and the possibilities of confusion of the attribute value indicated by reference information as the certainty factor of the attribute value set by a corrected search query. Examples of a statistical value include a mean, a weighted mean, a maximum value, a minimum value, a mode, and a median.

The reference information in FIG. 3 indicates 7% as the possibility of thirties being confused with fifties. Further, the reference information in FIG. 3 indicates 21% as the possibility of forties being confused with fifties. Then, the correction unit 12 sets a statistical value of 7% and 21% as the certainty factor of fifties in a corrected search query. The certainty factor of each attribute value set in an inspection query can be employed as a weight in a case of employing a weighted mean. Specifically, the weight for 7% is the certainty factor (20%) of thirties set in the search query. Then, the weight for 21% is the certainty factor (70%) of forties set in the search query.

### Example 2

As another example, the correction unit 12 may include another attribute value that may be confused with an attribute value with the highest certainty factor out of a plurality of attribute values of the same attribute set in a search query into a corrected search query.

In the search query in the aforementioned example, an attribute value with the highest certainty factor is forties. In the case of the example, the correction unit 12 includes thirties and fifties that may be confused with forties, and thirties and forties that are originally included in the search query into a corrected search query. The way a certainty factor is set is similar to that in the aforementioned example 1.

### Example 3

As another example, the correction unit 12 may include another attribute value that may be confused with all of a plurality of attribute values set by a search query into a corrected search query.

Another attribute value that may be confused with all of a plurality of attribute values set in the search query in the aforementioned example is fifties. In the case of the example, the correction unit 12 includes fifties, and thirties and forties that are originally included in the search query into a corrected search query. The way a certainty factor is set is similar to that in the aforementioned example 1.

### Modified Example 2

An attribute being a target of correction by the correction unit 12 and an attribute not being a target of correction by the correction unit 12 may be previously defined. Then, the correction unit 12 may set only an attribute value of an attribute defined as a correction target to be a correction target and may not set an attribute value of an attribute not defined as a correction target to be a correction target.

For example, an attribute that is not likely to be confused, such as gender, may be excluded from a correction target. Then, an attribute that is highly likely to be confused, such as age, may be set to be a correction target.

### Modified Example 3

The input acceptance unit 11 further accepts input of specification of the purpose of a search in addition to a search query. Then, the recommendation unit 14 determines an attribute or an attribute value associated with the specified purpose of the search as an attribute or an attribute value recommended to be specified by the search query.

Examples of the purpose of a search include a stray child search, a criminal search, and a lost property search. Note that the purpose of a search may include another purpose, or the purpose exemplified above may be further subdivided. Selectable purposes of a search may be previously defined. Then, a user may specify one purpose out of the options.

In the modified example, information in which at least one attribute or one attribute value is associated with the purpose of each search is preregistered in the search apparatus 10. The recommendation unit 14 determines an attribute or an attribute value associated with the specified purpose of the search, based on the information.

An attribute or an attribute value to be focused on may vary depending on the purpose of a search. For example, in a case where the purpose of a search is a search for a purse snatcher, focusing on belongings is effective. By including possession of an article with a feature of a snatched object into a search query, increase in the probability of a successful search for a search target is expected.

### Modified Example 4

The search unit 13 searches for an image including a person matching a set search query. Then, the input acceptance unit 11 further accepts input of specification of at least one of the location and the time period where and when the person was sighted in addition to a search query.

The recommendation unit 14 determines an attribute or an attribute value associated with at least one of the specified location and the specified time period as an attribute or an attribute value recommended to be specified by the search query.

In the modified example, information in which at least one attribute or attribute value is associated with each location where a person was sighted and each time period in which the person was sighted is preregistered in the search apparatus 10. The recommendation unit 14 determines an attribute or an attribute value associated with at least one of the specified location and the specified time period, based on the information.

An attribute or an attribute value to be focused on may vary depending on the location and the time period where and when a person was sighted. For example, in a case where the time period in which a person being a search target was sighted is nighttime, an eyewitness is highly likely not to recognize a detailed feature of the person. Therefore, in such a case, it is preferable that an attribute of a detailed part, such as a feature of shoes, or an attribute value thereof be not included in a search query and a relatively easily recognizable attribute, such as a physical constitution or gender, or an attribute value thereof be included in the search query. By thus avoiding inclusion of vague information in the search query, a high-precision search for the search target can be performed. On the other hand, in a case where the time period in which a person being a search target was sighted is daytime, an eyewitness may recognize a detailed feature of the person. Therefore, in such a case, it is preferable to include an attribute of a detailed part, such as a feature of shoes, or an attribute value thereof in the search query. Thus, a high-precision search for the search target can be performed.

Further, in a case where the location where a person being a search target was sighted is a crowd or the like, an eyewitness is highly likely not to recognize a detailed feature of the person. Therefore, in such a case, it is preferable that an attribute of a detailed part, such as a feature of shoes, or an attribute value thereof be not included in a search query and a relatively easily recognizable attribute, such as a physical constitution or gender, or an attribute value thereof be included in the search query. By thus avoiding inclusion of vague information in the search query, a high-precision search for the search target can be performed. On the other hand, in a case where the location where a person being a search target was sighted is a relatively empty location, an eyewitness may recognize a detailed feature of the person. Therefore, in such a case, it is preferable to include an attribute of a detailed part, such as a feature of shoes, or an attribute value thereof in the search query. Thus, a high-precision search of the search target can be performed.

### Modified Example 5

The recommendation unit 14 may determine an attribute value recommended to be deleted from among attribute values specified by a search query and output the attribute value. For example, the recommendation unit 14 may determine an attribute value the narrowing-down capability of which in a case of being combined with a predetermined attribute value specified by a search query is lower than a reference level from among attribute values specified by the search query. For example, the determination is achieved by using a learning model described in the second example embodiment. Then, the recommendation unit 14 may determine the determined attribute value as an attribute value recommended to be deleted and output the attribute value.

### Modified Example 6

The search apparatuses 10 according to the aforementioned example embodiments each perform a search, based on a search query specifying an attribute value and a certainty factor. As a modified example, the search apparatus 10 may perform a search, based on an attribute value, without using a certainty factor. A search based on an attribute value can be achieved by using every well-known technology.

### Modified Example 7

The search unit 13 may execute both a search (hereinafter a “first search”) based on a search query accepted by the input acceptance unit 11 (a search query set by a user) and a search (hereinafter a “second search”) based on a corrected search query generated by the correction unit 12. Then, the search apparatus 10 may output the result of the first search and the result of the second search to a user and output information inquiring of the user about whether a correction to the search query can be executed. Then, the search apparatus 10 may execute a correction to the search query in response to a user input to the effect that a correction to the search query can be executed.

In this case, the search query accepted by the input acceptance unit 11 is displayed in a search query field on a search screen. Then, the result of the first search and the result of the second search are displayed on the search screen in a state of the search query being displayed in the search query field. Then, in response to a user input to the effect that a correction to the search query can be executed, the contents of the search query field are changed from the search query accepted by the input acceptance unit 11 to the corrected search query generated by the correction unit 12.

Note that, at the time when outputting the result of the first search and the result of the second search to a user, the search apparatus 10 may output only a predetermined number from the top in both results to the user. Further, at the time when outputting the result of the first search and the result of the second search to a user, the search apparatus 10 may highlight the difference between both results.

While the example embodiments of the present invention have been described above with reference to the drawings, the example embodiments are exemplifications of the present invention, and various configurations other than those described above may also be employed. The configurations according to the aforementioned example embodiments may be combined or may be partially substituted by another configuration. Further, various modifications may be made to the configurations according to the aforementioned example embodiments without departing from the spirit thereof. Further, the configurations and processing disclosed in the aforementioned example embodiments and the modified examples thereof may be combined.

Further, a plurality of processes (processing) are described in a sequential order in each of a plurality of flowcharts used in the aforementioned description. However, the execution order of processes executed in each example embodiment is not limited to the order of description. The order of the illustrated processes may be modified without affecting the contents in each example embodiment. Further, the aforementioned example embodiments may be combined without contradicting each other.

The whole or part of the example embodiments disclosed above may also be described as, but not limited to, the following supplementary notes.

1. A search apparatus including:
an input acceptance unit that accepts a search query specifying an attribute value and a certainty factor of the attribute value for at least one attribute;
a correction unit that generates a corrected search query by correcting the search query, based on reference information indicating the another attribute value that may be confused with the each attribute value, and the attribute value and the certainty factor that are specified by the search query;
a search unit that searches one or more pieces of registration information registered in a database for the registration information matching the corrected search query; and
a recommendation unit that determines and outputs the attribute or the attribute value recommended to be specified by the search query, based on at least one of the corrected search query and the reference information.
   2. The search apparatus according to supplementary note 1, wherein
the reference information indicates a possibility of the each attribute value being confused with the another attribute value, and
the recommendation unit determines the attribute value recommended to be specified by the search query, based on a capability to narrow down a number of pieces of the registration information matching in the search performed with the search query in which the registration information is newly specified, the capability being computed for the each attribute value, and the possibility of the each attribute value.
   3. The search apparatus according to supplementary note 2, wherein
the recommendation unit
   computes an integrated score for the each attribute value, based on the possibility of the each attribute value and the narrowing-down capability,
   computes the higher integrated score as the possibility and the narrowing-down capability increase, and
   determines the attribute value the integrated score of which is equal to or greater than a reference value, the attribute value the integrated score of which is included within a predetermined number from a top, or the attribute value the integrated score of which is included within a predetermined ratio from a top as the attribute value recommended to be specified by the search query.
      4. The search apparatus according to supplementary note 2 or 3, wherein
the recommendation unit
   computes an integrated score for the each attribute value, based on the possibility of the each attribute value and the narrowing-down capability,
   computes the lower integrated score as the possibility and the narrowing-down capability increase, and
   determines the attribute value the integrated score of which is equal to or less than a reference value, the attribute value the integrated score of which is included within a predetermined number from a bottom, or the attribute value the integrated score of which is included within a predetermined ratio from a bottom as the attribute value recommended to be specified by the search query.
      5. The search apparatus according to any one of supplementary notes 2 to 4, wherein
the recommendation unit computes the narrowing-down capability of the each attribute value, based on a learning model being generated based on learning data indicating a change in a number of pieces of the registration information matching in the search in a case of newly specifying the predetermined attribute value in the predetermined search query, inputting the search query, and outputting a score indicating the narrowing-down capability of the each attribute value.
   6. The search apparatus according to any one of supplementary notes 1 to 5, wherein the recommendation unit determines the attribute or the attribute value not included in the corrected search query as the attribute or the attribute value recommended to be specified by the search query.
   7. The search apparatus according to any one of supplementary notes 1 to 6, wherein,
in a case where the search query includes a first attribute value of a first attribute, the correction unit generates the corrected search query including the first attribute value of the first attribute and a second attribute value of the first attribute, and
the first attribute value and the second attribute value are different from each other.
   8. The search apparatus according to supplementary note 7, wherein the correction unit generates the corrected search query including, as the second attribute value, the attribute value indicated in reference information to have a possibility of being confused with the first attribute value, the reference information indicating the another attribute value that may be confused with the each attribute value.
   9. A search method including, by one or more computers:
accepting a search query specifying an attribute value and a certainty factor of the attribute value for at least one attribute;
generating a corrected search query by correcting the search query, based on reference information indicating the another attribute value that may be confused with the each attribute value, and the attribute value and the certainty factor that are specified by the search query;
searching one or more pieces of registration information registered in a database for the registration information matching the corrected search query; and
determining and outputting the attribute or the attribute value recommended to be specified by the search query, based on at least one of the corrected search query and the reference information.
   10. A program causing a computer to function as:
an input acceptance unit that accepts a search query specifying an attribute value and a certainty factor of the attribute value for at least one attribute;
a correction unit that generates a corrected search query by correcting the search query, based on reference information indicating the another attribute value that may be confused with the each attribute value, and the attribute value and the certainty factor that are specified by the search query;
a search unit that searches one or more pieces of registration information registered in a database for the registration information matching the corrected search query; and a recommendation unit that determines and outputs the attribute or the attribute value recommended to be specified by the search query, based on at least one of the corrected search query and the reference information.

This application claims priority based on Japanese Patent Application No. 2022-204369 filed on Dec. 21, 2022, the disclosure of which is hereby incorporated by reference thereto in its entirety.

Reference Signs List

| | |
|---|---|
| 10 | Search apparatus |
| 11 | Input acceptance unit |
| 12 | Correction unit |
| 13 | Search unit |
| 14 | Recommendation unit |
| 1A | Processor |
| 2A | Memory |
| 3A | Input/output I/F |
| 4A | Peripheral circuit |
| 5A | Bus |

What is claimed is:

1. A search apparatus comprising:
at least one memory configured to store one or more instructions; and
at least one processor configured to execute the one or more instructions to:
accept a search query specifying an attribute value and a certainty factor of the attribute value for at least one attribute;
generates generate a corrected search query by correcting the search query, based on reference information indicating the another attribute value that may be confused with the each attribute value, and the attribute value and the certainty factor that are specified by the search query;
search one or more pieces of registration information registered in a database for the registration information matching the corrected search query;
determine the attribute or the attribute value recommended to be specified by the search query, based on at least one of the corrected search query and the reference information; and
output the attribute or the attribute value recommended to be specified by the search query.

2. The search apparatus according to claim 1, wherein
the reference information indicates a possibility of the each attribute value being confused with the another attribute value, and
the at least one processor is further configured to execute the one or more instructions to determine the attribute value recommended to be specified by the search query, based on a capability to narrow down a number of pieces of the registration information matching in the search performed with the search query in which the registration information is newly specified, the capability being computed for the each attribute value, and the possibility of the each attribute value.

3. The search apparatus according to claim 2, wherein
the at least one processor is further configured to execute the one or more instructions to
compute an integrated score for the each attribute value, based on the possibility of the each attribute value and the narrowing-down capability,
compute the higher integrated score as the possibility and the narrowing-down capability increase, and
determine the attribute value the integrated score of which is equal to or greater than a reference value, the attribute value the integrated score of which is included within a predetermined number from a top, or the attribute value the integrated score of which is included within a predetermined ratio from a top as the attribute value recommended to be specified by the search query.

4. The search apparatus according to claim 2, wherein
the at least one processor is further configured to execute the one or more instructions to
compute an integrated score for the each attribute value, based on the possibility of the each attribute value and the narrowing-down capability,
compute the lower integrated score as the possibility and the narrowing-down capability increase, and
determine the attribute value the integrated score of which is equal to or less than a reference value, the attribute value the integrated score of which is included within a predetermined number from a bottom, or the attribute value the integrated score of which is included within a predetermined ratio from a bottom as the attribute value recommended to be specified by the search query.

5. The search apparatus according to claim 2, wherein
the at least one processor is further configured to execute the one or more instructions to compute the narrowing-down capability of the each attribute value, based on a learning model being generated based on learning data indicating a change in a number of pieces of the registration information matching in the search in a case of newly specifying the predetermined attribute value in the predetermined search query, inputting the search query, and outputting a score indicating the narrowing-down capability of the each attribute value.

6. The search apparatus according to claim 1, wherein
the at least one processor is further configured to execute the one or more instructions to determine the attribute or the attribute value not included in the corrected search query as the attribute or the attribute value recommended to be specified by the search query.

7. The search apparatus according to claim 1, wherein,
the at least one processor is further configured to execute the one or more instructions to, in a case where the search query includes a first attribute value of a first attribute, generate the corrected search query including the first attribute value of the first attribute and a second attribute value of the first attribute, and
the first attribute value and the second attribute value are different from each other.

8. The search apparatus according to claim 7, wherein
the at least one processor is further configured to execute the one or more instructions to generate the corrected search query including, as the second attribute value, the attribute value indicated in reference information to have a possibility of being confused with the first attribute value, the reference information indicating the another attribute value that may be confused with the each attribute value.

9. A search method comprising, by one or more computers:
accepting a search query specifying an attribute value and a certainty factor of the attribute value for at least one attribute;
generating a corrected search query by correcting the search query, based on reference information indicating the another attribute value that may be confused with the each attribute value, and the attribute value and the certainty factor that are specified by the search query;
searching one or more pieces of registration information registered in a database for the registration information matching the corrected search query;
determining the attribute or the attribute value recommended to be specified by the search query, based on at least one of the corrected search query and the reference information; and
outputting the attribute or the attribute value recommended to be specified by the search query.

10. The search method according to claim 9, wherein
the reference information indicates a possibility of the each attribute value being confused with the another attribute value, and
the search method further comprises, by the one or more computers, determining the attribute value recommended to be specified by the search query, based on a capability to narrow down a number of pieces of the registration information matching in the search performed with the search query in which the registration information is newly specified, the capability being computed for the each attribute value, and the possibility of the each attribute value.

11. The search method according to claim 10, further comprising, by the one or more computers:
computing an integrated score for the each attribute value, based on the possibility of the each attribute value and the narrowing-down capability;
computing the higher integrated score as the possibility and the narrowing-down capability increase; and
determining the attribute value the integrated score of which is equal to or greater than a reference value, the attribute value the integrated score of which is included within a predetermined number from a top, or the attribute value the integrated score of which is included within a predetermined ratio from a top as the attribute value recommended to be specified by the search query.

12. The search method according to claim 10, further comprising, by the one or more computers:
computing an integrated score for the each attribute value, based on the possibility of the each attribute value and the narrowing-down capability;
computing the lower integrated score as the possibility and the narrowing-down capability increase; and
determining the attribute value the integrated score of which is equal to or less than a reference value, the attribute value the integrated score of which is included within a predetermined number from a bottom, or the attribute value the integrated score of which is included within a predetermined ratio from a bottom as the attribute value recommended to be specified by the search query.

13. The search method according to claim 10, further comprising, by the one or more computers,
computing the narrowing-down capability of the each attribute value, based on a learning model being generated based on learning data indicating a change in a number of pieces of the registration information matching in the search in a case of newly specifying the predetermined attribute value in the predetermined search query, inputting the search query, and outputting a score indicating the narrowing-down capability of the each attribute value.

14. The search method according to claim 9, further comprising, by the one or more computers,
determining the attribute or the attribute value not included in the corrected search query as the attribute or the attribute value recommended to be specified by the search query.

15. A non-transitory computer-readable medium on which a program is stored, the program causing a computer to:
accept a search query specifying an attribute value and a certainty factor of the attribute value for at least one attribute;
generate a corrected search query by correcting the search query, based on reference information indicating the another attribute value that may be confused with the each attribute value, and the attribute value and the certainty factor that are specified by the search query;
search one or more pieces of registration information registered in a database for the registration information matching the corrected search query; and
determine the attribute or the attribute value recommended to be specified by the search query, based on at least one of the corrected search query and the reference information; and
output the attribute or the attribute value recommended to be specified by the search query.

16. The non-transitory computer-readable medium according to claim 15, wherein
the reference information indicates a possibility of the each attribute value being confused with the another attribute value, and
the program causes the computer to determine the attribute value recommended to be specified by the search query, based on a capability to narrow down a number of pieces of the registration information matching in the search performed with the search query in which the registration information is newly specified, the capability being computed for the each attribute value, and the possibility of the each attribute value.

17. The non-transitory computer-readable medium according to claim 16, wherein
the program causes the computer to
compute an integrated score for the each attribute value, based on the possibility of the each attribute value and the narrowing-down capability,
compute the higher integrated score as the possibility and the narrowing-down capability increase, and
determine the attribute value the integrated score of which is equal to or greater than a reference value, the attribute value the integrated score of which is included within a predetermined number from a top, or the attribute value the integrated score of which is included within a predetermined ratio from a top as the attribute value recommended to be specified by the search query.

18. The non-transitory computer-readable medium according to claim 16, wherein
the program causes the computer to
compute an integrated score for the each attribute value, based on the possibility of the each attribute value and the narrowing-down capability,
compute the lower integrated score as the possibility and the narrowing-down capability increase, and
determine the attribute value the integrated score of which is equal to or less than a reference value, the attribute value the integrated score of which is included within a predetermined number from a bottom, or the attribute value the integrated score of which is included within a predetermined ratio from a bottom as the attribute value recommended to be specified by the search query.

19. The non-transitory computer-readable medium according to claim 16, wherein
the program causes the computer to compute the narrowing-down capability of the each attribute value, based on a learning model being generated based on learning data indicating a change in a number of pieces of the registration information matching in the search in a case of newly specifying the predetermined attribute value in the predetermined search query, inputting the search query, and outputting a score indicating the narrowing-down capability of the each attribute value.

20. The non-transitory computer-readable medium according to claim 15, wherein
the program causes the computer to determine the attribute or the attribute value not included in the corrected search query as the attribute or the attribute value recommended to be specified by the search query.
